(19) United States
(12) Patent Application Publication
(10) Pub. No.: US 2003/0182413 A1
(43) Pub. Date: Sep. 25, 2003

(54) System and method for selecting a service provider

(76) Inventors: Matthew Robert Allen, Hunters Hill (AU); Douglas Robert Hudgeon, Double Bay (AU)

Correspondence Address: Stephen M. De Klerk, Blakely, Sokoloff, Taylor & Zafman LLP, Seventh Floor, 12400 Wilshire Boulevard, Los Angeles, CA, 90025-1030, US

(21) Appl. No.: 10/308,519

(22) Filed: Dec. 2, 2002

Related U.S. Application Data
(63) Continuation-in-part of application No. PCT/AU01/00660, filed on Jun. 4, 2001.

(30) Foreign Application Priority Data
Jul. 23, 2002 (AU) 2002950348
Jul. 4, 2002 (AU) PS3385
Nov. 15, 2000 (AU) PR1461
Sep. 25, 2000 (AU) PR0336
Jun. 30, 2000 (AU) PQ8505
Jun. 2, 2000 (AU) PQ7914

(51) Int. Cl. G06F 15/173

(52) U.S. Cl. 709/223

(57) ABSTRACT

A preferred embodiment provides a selection system to facilitate the provision of services on a computer network to prospective service users. According to a first aspect of the invention provides a system for enabling the selection of a service provider from a plurality of service providers for the performance of a job, said system including, a database which is accessible by a service user via a network, the database including a plurality of records, each record being associated with a service provider, wherein each record includes a service provider profile including a plurality of comparable performance criteria indicative of the performance attributes of the service provider; interface means for receiving a job request comprising at least one desired performance criterion from said service user, and processor means for comparing the stored comparable performance criteria and the at least one desired performance criterion, and for extracting at least one preferred service provider from the database on the basis of said comparison. The invention also provides a method of enabling a service user to select a service provider from a plurality of service providers for the performance of a job, said method including the steps of: providing a database which is accessible by the service user via a network, storing in said database a plurality of records, each record being associated with a service provider, wherein each record includes a service provider profile including a plurality of comparable performance criteria indicative of the performance attributes of the service provider; receiving a job request comprising at least one desired performance criterion from said service user, comparing the plurality of stored performance criteria with the desired performance criterion, and automatically selecting at least one preferred service provider from the database on the basis of said comparison.

### CROSS-REFERENCE TO OTHER APPLICATIONS

This Application is a continuation-in-part of International Application No. PCT/AU01/00660, filed on Jun. 4, 2001. Benefit is also claimed from Australian Patent Application Nos. 2002950348 filed on Jul. 23, 2002; PS3385 filed on Jul. 4, 2002; PR1461 filed on Nov. 15, 2000; PR0336 filed on Sep. 25, 2000; PQ8505 filed on Jun. 30, 2000; and PQ7914 filed on Jun. 2, 2000.

### COPYRIGHT NOTICE/PERMISSION

A portion of the disclosure of this patent document, and in particular Annexures A and B, contain material which is subject to copyright protection. The copyright owner has no objection to the facsimile reproduction by anyone of the patent document as it appears in patent office records once publicly available, but otherwise reserves all copyright rights whatsoever. The following notice applies to the software and data as described and illustrated below: Copyright 2000, 2001, 2002, River Dynamics Pty Ltd., All rights reserved.

### FIELD OF THE INVENTION

The present invention relates to a system and method for allowing a service user to quantify and compare the desirability of competing service providers, and to select a service provider to perform a particular service.

### BACKGROUND OF THE INVENTION

Potential purchasers of goods are often able to choose the product most appropriate to their needs by examining the product and assessing the quality of its construction and its suitability to the purchaser's needs. Usually, the price of the goods are known and therefore the purchaser may be able to base their purchase decision on a cost/benefit analysis of the product.

In contrast to goods, potential users of a service generally do not have the same level of information available to them on which to base their selection of a service provider. Therefore the process of ascertaining which service provider is the most appropriate, efficient and/or cost effective provider to perform a job can be complex and time consuming process.

Traditionally services have been procured using a tendering process. Participating service providers prepare a proposal in response to a tender request made by the service user. The service user can then compare the proposals and select the most desirable service provider.

As the need for the service user to perform research into the potential service providers is reduced, the service users perceive that there is a time and cost advantage to them in using a tender system. However, the perceived advantages of a tender system may not be borne out in actuality for a number of reasons. For example, the tender documents from all of the potential suppliers may not be readily comparable due to different terminology, methodology or charging practices of the suppliers, and hence additional effort is required to perform the comparison between the various tender responses received. Furthermore, in situations where a service user (or group of service users) have a large number of low cost jobs to be performed, the time and effort expended in compiling, reviewing and comparing tenders may make using a tendering process both slow and uneconomical for both buyers and sellers.

In particular, a tendering system also become disadvantageous for the suppliers when the cost and effort required to submit a tender for a job outweighs the profit of performing the job.

### SUMMARY OF THE INVENTION

In the specification and claims the term “services” should be understood to extend to services that include the provision of associated goods or spare parts as a sub-component of the service.

According to a first aspect of the present invention there is provided a system for enabling the selection of a service provider from a plurality of service providers for the performance of a job, said system including:

a database which is accessible by a service user via a network, the database including a plurality of records, each record being associated with a service provider, wherein each record includes a service provider profile including a plurality of comparable performance criteria indicative of the performance attributes of the service provider;

interface means for receiving a job request comprising at least one desired performance criterion from said service user, and

processor means for comparing the stored comparable performance criteria and the at least one desired performance criterion, and for extracting at least one preferred service provider from the database on the basis of said comparison.

Preferably the processor means is arranged to extract a plurality of service providers from the database on the basis of said comparison, and to compile a list of the plurality of preferred service providers for distribution to the service user.

Preferably said database is additionally accessible by said service providers via a network for enabling the service providers to update their associated performance profiles.

Conveniently said system includes prioritising means for allowing at least two desired performance criteria to be prioritised in accordance with user-selected priorities, and wherein said comparison is made in accordance with said prioritisation.

It is also preferable that the system includes weighting means for weighting at least some of the comparable performance criteria according to their relative importance to the user, to enable said comparison to be made in accordance with said weightings.

It is also preferable that the database includes at least one historical rating field associated with each service provider for enabling a service user to rate at least one past job performed by the service provider.

The at least one desired performance criterion and said comparable performance criteria are preferably selected from a group including the following classes of criteria:

quality criteria, cost criteria and timeliness criteria.

Quality criteria preferably relate to the quality and extent of the resources drawn on by the service provider.

Cost criteria preferably relate to at least one of the following, namely the current cost structure of the service provider, the average cost of similar jobs performed by the service provider in the past, and discounts offered by the service provider.

Timeliness criterion preferably reflects the timeliness of at least one past job performed by the service provider.

Each service provider profile preferably includes at least one qualifying criterion indicative of the ability of the service provider to perform the job, and wherein the job request includes at least one desired qualifying criterion.

It is also preferable that said qualifying criteria relate to at least one of the following, namely the type of service, the area of operation of the service provider and the availability of the service provider.

Preferably the interface means is adapted to receive a selection confirmation from said service user identifying the service provider selected for the job.

It is also preferable that said system additionally includes generating means for generating and sending a job confirmation message to the service provider selected by the service user for the job.

In a preferred embodiment the job to be performed is an investigation.

According to a second aspect of the present invention there is provided a method of enabling a service user to select a service provider from a plurality of service providers for the performance of a job, said method including the steps of:

providing a database which is accessible by the service user via a network,

storing in said database a plurality of records, each record being associated with a service provider, wherein each record includes a service provider profile including a plurality of comparable performance criteria indicative of the performance attributes of the service provider;

receiving a job request comprising at least one desired performance criterion from said service user,

comparing the plurality of stored performance criteria with the desired performance criterion, and automatically selecting at least one preferred service provider from the database on the basis of said comparison.

Preferably a plurality of preferred service providers are automatically selected from the database, and said method additionally includes the step of:

compiling a list of the plurality of preferred service providers.

Preferably the method includes the additional step of:

periodically capturing and storing updated performance criteria in order to update the stored profile of least one service provider.

It is also preferable that the database is accessible by said plurality of service providers and wherein said method includes the additional step of:

enabling the service providers periodically to update their associated performance profiles in the database.

Preferably the job request includes a plurality of desired performance criteria and said method additionally includes the steps of:

enabling the service user to prioritise at least two desired performance criteria; and

automatically selecting the at least one preferred service provider on the basis of the prioritisation.

It is also preferable that the method includes the steps of:

allowing said user to allocate a weighting to said comparative performance criteria indicative of the relative importance of said comparative performance criteria to the service user; and

automatically selecting the at least one preferred service provider at least partly on the basis of said weightings.

In a preferred embodiment the database includes at least one historical rating field associated with each service provider, and said method includes the steps of:

enabling a service provider to rate at least one past job performed by said service provider; and

capturing said rating in said at least one historical rating field associated with the service provider.

Preferably the said service provider profiles includes at least one stored qualifying criterion indicative of the ability of a service provider to perform the job, and in which said job request includes at least one qualifying criterion, wherein said method includes the initial step of;

comparing said stored qualifying criterion with said desired qualifying criterion to select at least one qualified service provider on the basis of said comparison;

wherein at least one preferred service provider is a subset of at least one qualified service provider so selected.

The qualifying criteria preferably relate to at least one of the following, the namely type of service, the area of operation of the service provider and the availability of the service provider.

Said method preferably includes the step of receiving a selection confirmation from said service user, stating at least the preferred service provider selected by the user.

In a further preferred embodiment the method includes the step of:

generating and sending a job confirmation message to the service provider selected by the service user.

Preferably the services are insurance investigation services.

The invention extends to a computerized method of enabling a buyer to select a service provider for performing a service; said method including the steps of:

(a) processing a service enquiry for a particular service;

(b) retrieving historical cost data associated with said service in respect of a plurality of service providers in response to said enquiry;

(c) processing said historical cost data to arrive at comparable cost data in respect of said service providers for enabling the selection of a service provider to perform the particular service;

(d) capturing cost data relating to the provision of the particular service by the selected service provider, and

(e) updating the historical cost data by incorporating said captured cost data.

Conveniently, the method includes the additional steps of repeating steps (a) to (e) to enable a buyer to select a service provider for the provision of subsequent services with the aid of regularly updated cost data.

Advantageously, the method includes the step of compiling an historical cost dataset including historical cost data associated with the provision of at least one similar previous service by each service provider.

Typically, the service enquiry includes a plurality of service components and the historical cost data includes historical cost data for a plurality of comparable service components, and step (c) includes the sub-step of:

processing said historical cost data to arrive at cost data for each of said service components.

The cost data captured in step (d) may include cost data for each of the service components included in the service enquiry.

The service components may include cost per unit of time and distance, in combination with units of time and distance.

Preferably, the method includes the steps of:

(f) retrieving historical quality data associated with said service in respect of a plurality of service providers in response to said enquiry; and

(g) processing said historical quality data to arrive at comparable quality data in respect of said service providers to enable the selection of a service provider to perform the particular service.

The method may include the further steps of:

(h) capturing quality data relating to the provision of the particular service by the selected service provider; and

(i) updating the historical quality data to reflect said captured quality data.

Steps (f) to (i) are typically repeated to assist a buyer to select a service provider for the provision of subsequent services with the aid of regularly updated quality data.

The method may include the step of compiling an historical quality dataset including historical quality data associated with the provision of at least one previous service by each service provider.

The historical quality data may include historical quality data for a plurality of performance attributes, and the service request enquiry may include a plurality of comparable performance attribute weightings reflecting the relative importance of at least two of the performance attributes to the buyer.

Step (g) typically includes the sub-step of processing said historical quality data in respect of each of the performance attributes to arrive at comparable performance data in respect of each performance attribute, and combining said comparable performance data according to performance attribute weightings contained in the service enquiry for each service provider, to generate said comparable quality data.

The method may include the step of quantifying the selected quality factors using any derived scale, weighting such factors according to their relative importance, normalising the factors and combining them with the similarly normalised historical cost factors, in combination with an additional weighting factor.

By the term “quality data” is meant any non price-related factor which may influence the decision of the buyer to select a particular seller. Typical examples include effectiveness and result factors, level of competence comprehensiveness, turn-around or implementation time, completeness, value added components, safety factors, and the like.

The comparable cost data and comparable quality data in respect of each of the service providers may be combined to derive a comparable performance index for each service provider for enabling the selection of a service provider to perform the particular service, with the combination of the comparable cost data and comparable quality data being arranged in accordance with weightings reflecting the relative importance of the comparable cost data and comparable quality data to the buyer.

According to a still further aspect of the invention there is provided a computerized method of enabling a buyer to select a service provider for performing a service, said method including the steps of:

(a) compiling historical cost and quality datasets including historical cost and quality data associated with the provision of at least one previous service by each service provider.

(b) receiving and processing a service enquiry from the buyer for a particular service;

(c) retrieving historical cost and quality data associated with said service in respect of a plurality of service providers in response to said enquiry; and

(d) processing said historical cost and quality data to arrive at comparable cost and quality data in respect of said service providers for enabling the selection of a service provider to perform the particular service.

The method preferably includes the subsequent steps of:

(e) capturing cost and quality data relating to the provision of the particular service by the selected service provider;

(f) updating the historical cost and quality data to incorporate said captured cost and quality data, and repeating steps (b) to (f) to enable a buyer to select a service provider for the provision of subsequent services.

The method may include the steps of formatting the service enquiry into a plurality of service components, and formatting the historical cost and quality data into a plurality of comparable service components, with step (d) including the sub-step of:

processing said historical cost and quality data to arrive at cost and quality data for each of said components.

The invention extends to a computer-readable medium having stored thereon executable instructions for causing a computer to perform a method of enabling a buyer to select a service provider for performing a service; said method including the steps of:

(a) processing a service enquiry for a particular service;

(b) retrieving historical cost data associated with said service in respect of a plurality of service providers in response to said enquiry;

(c) processing said historical cost data to arrive at comparable cost data in respect of said service providers for enabling the selection of a service provider to perform the particular service;

(d) capturing cost data relating to the provision of the particular service by the selected service provider, and

(e) updating the historical cost data by incorporating said captured cost data.

Preferably, the computer-readable medium has further executable instructions for causing a computer to repeat steps (a) to (e) to enable a buyer to select a service provider for the provision of subsequent services with the aid of regularly updated cost data.

The invention also provides a computer operating under the control of the computer readable medium.

The executable instructions may be in web-compatible Mark-up language such as HTML, XML, or XML/EDI.

According to a still further aspect of the invention there is provided a computer system to enable a buyer to select a service provider for performing a service; said system including:

enquiry processing means configured to receive and process a service enquiry for a particular service from the buyer;

a database configured to store historical cost data associated with said service in respect of a plurality of service providers;

a processor adapted to retrieve and process said historical cost data from said database in response to said query to arrive at comparable cost data in respect of said service providers for enabling the buyer to select a service provider, on the basis of said comparable cost data, to perform the particular service.

Preferably, the computer system includes data capture means configured to capture cost data relating to the provision of the particular service by the selected service provider; and updating means to update the historical cost data on the database with said captured cost data.

Typically, the enquiry processing means is configured to retrieve historical quality data associated with said service in respect of a plurality of service providers in response to said enquiry, and the processing means is configured to generate comparable quality data from said historical quality data in respect of said service providers.

The the historical quality data typically includes historical quality data for a plurality of performance attributes, and the service request enquiry includes a plurality of comparable performance attribute weightings reflecting the importance of each of the performance attributes to the buyer.

The processor may be configured to process said historical quality data in respect of each of the performance attributes to arrive at comparable performance data in respect of each performance attribute, and to combine the comparable performance data according to the performance attribute weightings included in the service enquiry for each service provider, to generate said comparable quality data.

The processor may be configured to derive a comparable performance index for each service provider by combining the comparable cost data and comparable quality data in respect of each of the service providers with the combination of the comparable cost data and comparable quality data being is performed in accordance with weightings reflecting the relative importance of the comparable cost data and comparable quality data to the buyer.

The invention further provides a computer system to enable a buyer to select a service provider for performing a service; said system including:

a database configured to store a first dataset including a plurality of service providers, a plurality of associated services and a plurality of associated historical costs;

a processor in communication with said database, wherein said processor is configured to receive historical cost data associated with each service provider and to generate comparative cost data for each service provider according to a predetermined algorithm; and

communication means configured to communicate said comparative cost data to said buyer to enable the buyer to select a service provider.

Preferably, the predetermined algorithm includes weighting means configured to weight a plurality of received historical cost data according to the respective associated service of the historical cost data, and to generate the comparative cost data in accordance with said weighting.

Conveniently, the processor includes weighting optimisation means adapted to optimise the weightings applied by the weighting means to the received historical cost data, with the weighting optimisation means utilizing an algorithm which has the effect of weighting the most recent data more heavily.

The computer system may further include data capture means configured to capture cost data associated with a current service provided by a service provider, and updating means adapted to update said first data set to include said cost data associated with the current service provided by a service provider.

Typically, the historical cost data includes a plurality of associated service components and associated historical cost component data; and the processor is configured to generate comparative cost data in respect of each service component for each service provider.

Conveniently, the data storage means is configured to store a second dataset including a plurality of service providers, a plurality of associated services and a plurality of associated historical quality data, and said processor means is configured to additionally receive historical quality data associated with each service provider and generate comparative quality data for each service provider according to a predetermined algorithm; and said communication means is arranged to communicate said comparative quality data to the buyer to enable the buyer to select a service provider.

The comparative quality data may comprise a comparable quality index which can be processed with the comparable cost data to yield a comparable desirability index, typically by a process of normalisation.

The present invention is based on the insight that an efficient marketplace can be encouraged if suppliers of services and/or goods know that their future workflow is determined by a systematic comparison of their historical costs and historical quality. Thus the present system and method encourages sellers of goods and/or services to provide a high quality of products and services at competitive rates in order to increase their likelihood of obtaining business in the future.

It will be understood that the invention disclosed and defined herein extends to all alternative combinations of two or more of the individual features mentioned or evident from the text or drawings. All of these different combinations constitute various alternative aspects of the invention.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 is a schematic illustration of a first embodiment of a selection system of the invention allowing a potential user of a service to select a provider of a service from a number of service providers;

FIG. 2 is a flowchart of the steps involved in implementing and using the system shown in FIG. 1;

FIG. 2A shows a flowchart of the steps involved in implementing an embodiment of the present invention, in which a cost effectiveness calculation for each potential service provider is provided to the service user;

FIGS. 3, 4 and 5 shows a series of displays from an Internet browser as seen by an insurance company when entering a job request into a selection system according to an embodiment of the present invention;

FIGS. 6 and 7 each show a display from an Internet browser as seen by an investigation company when entering their service profile into a selection system according to an embodiment of the present invention;

FIG. 7A shows another web page accessible by an investigation company and used for entering their costs for a plurality of service elements into a selection system according to an embodiment of the present invention;

FIG. 8 shows a screen of an Internet browser showing the pending “tenders” made by a service provider;

FIG. 9 shows a screen from an Internet browser as viewed an investigator showing available jobs in the selection system;

FIG. 10 shows a display from an Internet browser, as seen by an insurance company, listing a number of jobs for which job requests have been entered into a selection system according to an embodiment of the present invention;

FIG. 11 shows a screen capture of a webpage listing a number of potential service providers and associated quality rankings in respect of a job entered into the system by the insurance company;

FIG. 11A shows a screen capture from an Internet browser, as seen by an insurance company, setting out the performance criteria for a job entered into a selection system according to an embodiment of the present invention;

FIG. 12 shows a screen capture from an Internet browser, as viewed by an insurance company, which the insurance company can use to assign weightings to each of the performance criteria entered into the system by a service provider;

FIG. 13 shows a display of an Internet browser as seen by an insurance company listing all of the uncompleted jobs currently listed in the selection system;

FIG. 14 shows a display of an Internet browser as viewed by an investigation company showing a list of all uncompleted jobs for which they have been selected;

FIG. 15 shows a display of an Internet browser, as seen by an insurance company, which may be used to enter feedback on the quality, timeliness and cost effectiveness of a job performed by a service provider.

FIG. 16 shows a flow chart illustrating a method according to a second embodiment of the present invention;

FIG. 17 shows a portion of the historical cost data used for the production of the spreadsheet shown in FIG. 18;

FIG. 18 shows a spreadsheet configured to calculate comparable cost effectiveness rankings of service providers according to the second embodiment;

FIG. 19 shows a sample database of historical data request for surveillance investigations for a hypothetical buyer in connection with a third embodiment of the present invention; and

FIG. 20 shows a spreadsheet of a mean historical responses for three sellers for each question tabulated in the database of FIG. 19.

### DETAILED DESCRIPTION OF THE EMBODIMENTS

In broad concept the present invention provides a system which can be used by an individual or organisation wishing to select a supplier to provide goods associated with a service, perform a service, or do a job, from a group of suppliers. The preferred embodiment of the present invention provides a method and system for achieving an efficient marketplace between a group of sellers and at least one buyer, where the buyer, or buyers, repeatedly purchase products or services from the sellers. The preferred embodiment may advantageously be applied to situations where a high number of transactions between the buyer and the sellers occur, thus providing a large amount of historical data on which to base predictions of future cost, quality, timeliness or other desired performance criteria. However the present invention should not be construed to be limited to a market of this type.

Preferably in using the system and method as described the service providers are aware that the attributes of their services (in particular price) will be compared with those of other service providers, thereby fostering competition within the marketplace. Accordingly the system and method described may provide means for trading in services of relatively low value which has the benefits of a tender system without requiring service providers to tender on a job-by-job basis.

In the present embodiment the system is particularly suited for selecting services and/or goods supplied with an associated service, which can be readily broken down into a number of service components or elements. Typically service elements will be tasks or features of the service for which service providers can allocate a discrete fee, and which the procurer of the service can readily use to define the scope or quality of the service desired.

The first step in using the system according to this embodiment is initialisation. The initialisation process begins by defining the elements of the service and a set of performance criteria which describe them. The service performance criteria can be used by a service user to describe a job they need performed, and by the service provider to describe attributes of the services which they perform.

The performance criteria describing the services can include attributes relating, inter alia, to;

the nature of the services;

specific attributes of the services; and

the cost of the service, or the cost of specific elements of the service;

the quality or type of equipment and/or resources required to perform a service;

the qualifications or association memberships desired by people performing a service;

other attributes of the service provider performing the job, which can affect the kind, quality or style of service performed, such as the length of time the supplier has been in business etc; and

historical information relating to the performance of past services which may be indicative of the level of service provided, such as the percentage of past jobs completed within a set deadline; the satisfaction of previous service users with the service offered, and the historical cost of similar services performed.

As will be appreciated by the person skilled in the art, the extent of the performance criteria and the type of performance criteria used will vary depending on the breadth or type of services included in the system, the sophistication of the system desired and many other factors. For example, if the system is limited to selection of a service provider from a group who all perform identical services, then no functional criteria relating to the type of services performed will need to be defined. Alternatively, if various types of services are offered using the system then functional criteria will be required in order to determine service providers who are able to do a particular job. Moreover, the number of elements into which the services and/or associated goods are broken into can also vary depending on services and goods traded in the marketplace, the sophistication of the system desired, and many other factors. For example, a lawyer's invoice template will be divided into fields for photocopying charges, court appearance costs, legal research charges, professional time charges and other discrete elements of a lawyer's service for which a fee is charged. In a particularly simple system the services and/or associated goods can have only a single element.

The next step in the initialisation of the system is to build a database of service provider profiles, which contain a description of the services performed by each service provider in terms of the performance criteria. The performance criteria stored in the database for each service provider can include all, or only a subset, of the defined performance criteria. The service provider profiles stored in the database will typically be generated by allowing service providers to access the system, either via the Internet using a computer running an web browser application or a proprietary software program, and defining their service provider profile by answering a number of questions or by completing an online form etc. Direct access via a dedicated link to the database is also possible. Alternatively the operator of the system can set up the service provider profiles from data/information provided by the service suppliers.

Once the performance criteria are defined, a person or organisation wishing to procure a service can use the system to obtain a list of one or more service providers who are able to perform the service from the system, from which the most desirable service provider can be selected.

To obtain a list of suitable service providers the prospective service user sends a job request to the system describing a set of desired performance criteria for the job. In response to the request the system produces a list of one or more potential service providers whose performance criteria match the desired performance criteria requested by the service user.

It is also possible that the performance criteria specified by the service user can be grouped into two or more classes, for example a class of essential performance criteria that must be possessed by a service provider if they are to be chosen, and a class of inessential performance criteria which are preferred but not essential. Alternatively the performance criteria requested by the service provider can be weighted to express their relative importance to the user, or combined into quantitative measures of suitability with weightings applied to the performance criteria depending on the user's preferences. In this case the list of potential service provider(s) provided to the user will also typically include one or more suitability ratings or rankings based on the weighted or inessential performance criteria. From this list the service user can select a service provider.

Typically the price at which a service provider will do a job will be an important factor to a service user in choosing a service provider, and in fact it may be the only factor of interest the service user. The performance criteria related to the cost of each service provider can be used to generate a relative cost estimation of each service provider that can be presented to the service user to enable the most cost effective service provider to be selected. Three exemplary systems which provide a number of quantitative measures with weighted criteria, and a relative cost estimation are described below.

In preferred embodiments the system can be adapted to track the provision of the service and provide feedback on services currently in progress, or services provided in the past, to both the service providers and the service users. Furthermore, after a job has been completed by a chosen service provider, the service user is given the opportunity to submit their own evaluation of the service provider's performance criteria for the job just performed. Such historical data can be stored as performance criteria in the service provider's profile and used to compare the service provider with its competitors in the future and in a particularly preferred embodiment is used as the basis of a future cost estimation, as will be described below.

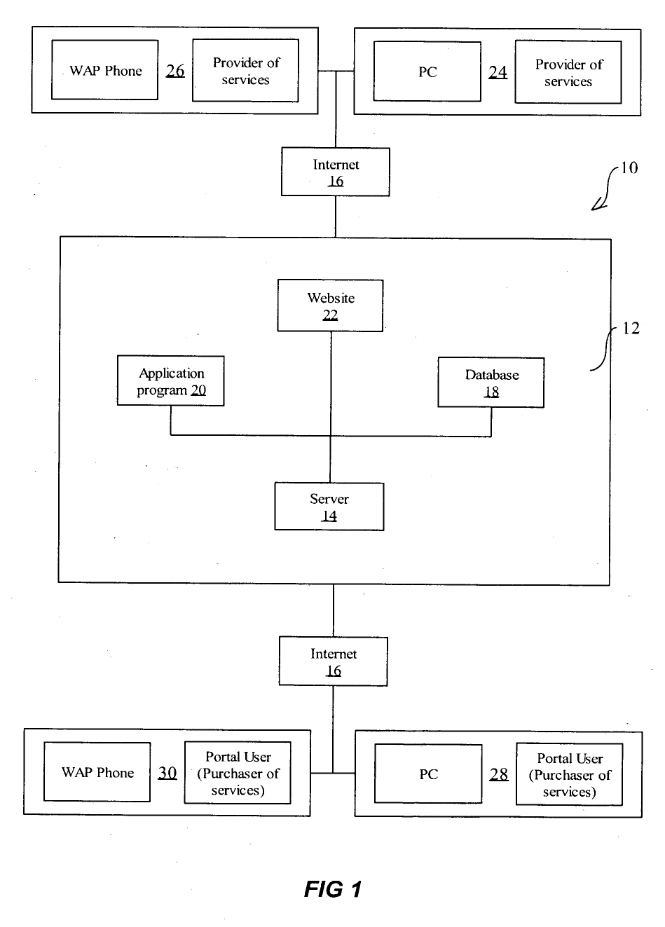

Referring to now FIG. 1, there is shown a schematic illustration of a computer network 10 comprising an interconnected network of computer terminals or the like, including a selection system server 12, a plurality of service providers' terminals 24, 26 and a plurality of service users' terminals 28,30. Interconnections between each of the abovementioned parties can be made via the Internet 16, or other networking means such as a LAN or WAN, a dedicated line or the like.

The selection system server 12 includes the following:

(a) a database 18 for storing a plurality of records containing service provider profiles for the service providers 24, 26 and optionally, a plurality of records containing performance criteria preferences for the service users connected to the system.

(b) an application program 20 for running the selection system; and

(c) data which constitutes a website(s) 22 which comprise a plurality of web pages that can be downloaded via the Internet 16 from the server 14, by either, or both service providers and prospective service users to enable the service providers and service users to interact with the system.

A number of service providers 24, 26 are registered with the selection system provider 12 ie. the service providers 24, 26 have a service provider profile stored in said database 18. For illustrative purposes two service providers, 24 and 26 are shown; however it is anticipated that a far greater number of service providers may offer their services via the selection system. Also shown in FIG. 1 are two typical service users 28 and 30, who are able to lodge a service request with the database 18 as described below.

The service providers and service users are able to access the website 22 stored on server 12 in order to use the selection system. In this example service provider 24 uses a personal computer to access the website 22 via the Internet 16, whilst service provider 26 downloads various pages from website 22 via the Internet 16, in XML format from their mobile phone with WAP capabilities. The service users 28,30 have access to the website 22 via the Internet 16 and are able to post service requests for the provision of services as will be explained below.

Various other system configurations could be used to implement a method according to the present invention, for example, the application program 20 may be built into the buyer's in-house software, in which case the server 12 and the database 18 will be part of the buyer's own computer system or network, rather than being housed in an external server. Alternatively, rather than having a central data base 18 the buyer's data may be stored by on the buyer's own computer or network and the each seller's data stored in the respective seller's computer or network. In this case, as the application program 20 requires a piece of stored data it is retrieved from the appropriate dataset. Interconnections between each of the above mentioned parties can be made via the internet or other networking means such as a LAN or WAN, or dedicated line or the like. The processor or marketplace software can also be made accessible by the sellers to allow them to view their historical data or change their personal, professional or operational details.

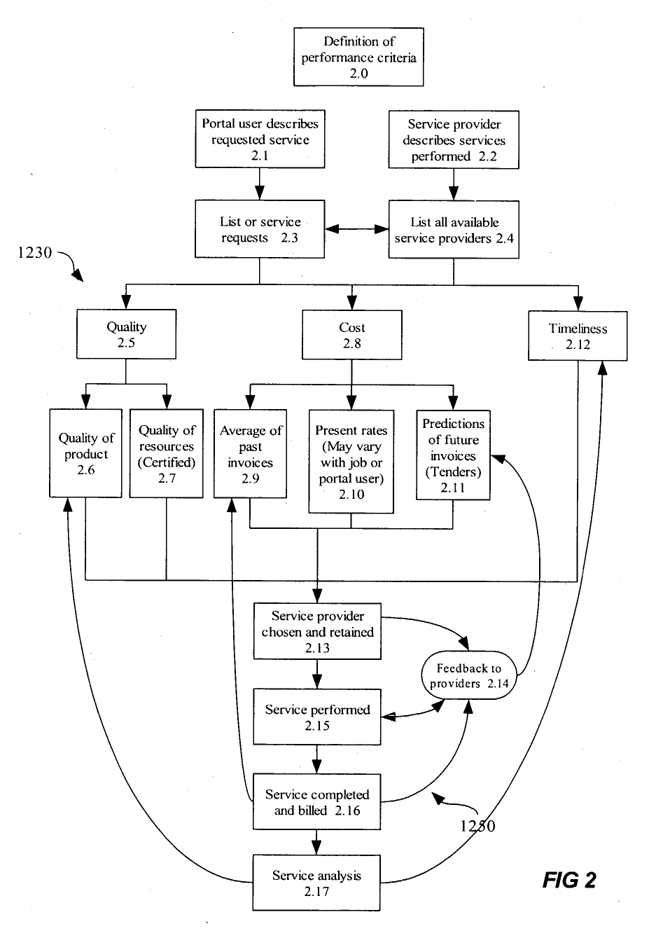

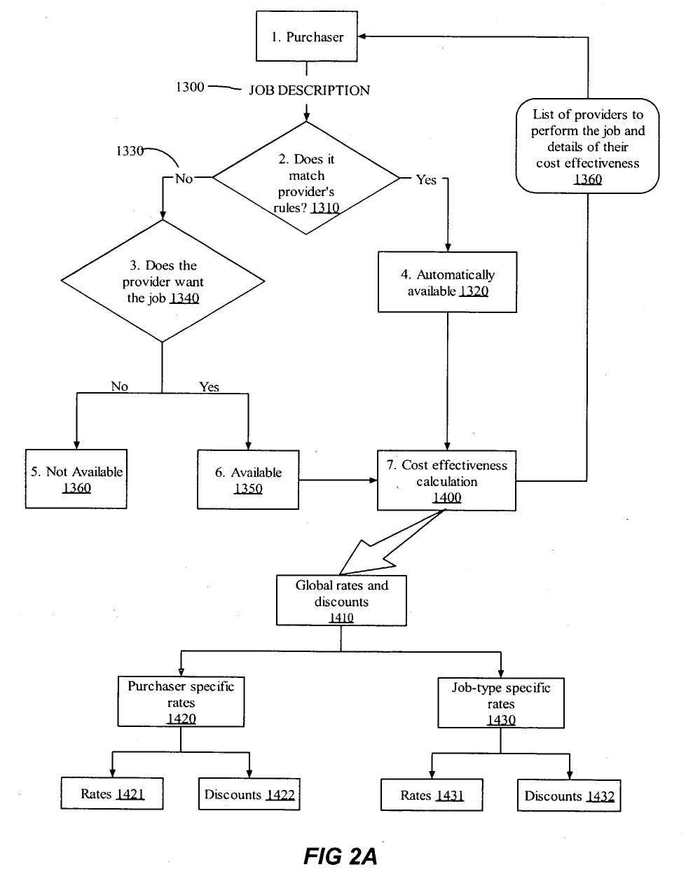

FIG. 2 shows a flow chart comprising a number of steps in a method of using the system of FIG. 1. In an initial step 2.0 a plurality of classes of performance criteria are defined describing the elements of the service to be procured using the service. The performance criteria defined in this embodiment are classified quality criteria, cost criteria, timeliness criteria groups. The quality criteria 2.5 are comprised of criteria relating to quality of the product 2.6, and quality of resources 2.7. The cost criteria 2.8 are comprised of criteria relating to the average cost of past invoices 2.9, present rates of service providers 2.10, and predictions of future invoices 2.11. Furthermore, functional performance criteria such as the type of service, and where and when the service will be preformed are also defined at 2.2 for the initial selection process.

Once the system is initialised in step 2.0 service providers define their service profiles which are stored in the database 18. The performance criteria used by the service providers include both functional criteria relating to jobs which they are able and willing to perform as well as information relating to the quality, costs and timeliness of services performed. In this embodiment, once historical data is accumulated it can be included in the performance criteria of a service provider.

In step 2.1 a portal user can send a job request describing a job for which they require a service provider. Such a job request will be made in terms of desired performance criteria for the service. As described above, this can include both functional criteria required by the service user and additional performance criteria which may affect their choice of service provider. In alternative embodiments the desired performance criteria can be ranked in order of importance to the service provider. The service user can additionally have a record stored on a database which contains a list of preferences which the service provider wishes to use in order to rank potential service providers.

In the present embodiment, once the service user makes a job request it is entered into a list of service requests in the selection system. The job request is interpreted by the selection system as a database query and extracts a list of potential service providers from the database whose service profiles match the job request. In order to receive the list extracted from the database the service user accesses the list of service requests and downloads a web page including a list of potential service providers whose performance criteria match at least those desired performance criteria included in the job request.

In order to generate the list of potential service providers the system performs a comparison between the desired performance criteria in the job request made by the service user and the performance criteria of each service provider. The list provided to the service user will only include the service providers who, according to their performance criteria are willing and able to perform the service desired. The list will also include a suitability rating for the quality, costs and timeliness of each service provider which the server user can use to select the most desirable service provider for the job.

The suitability ratings of quality, cost and timeliness are generated by comparing the performance criteria of each service provider to the other service providers, and numerically ranking the preselected service providers accordingly. As some of the performance criteria will be rated more highly by a service user than other criteria, a set of weightings are supplied by the service user when making a request, or are pre-loaded into the selection system in order to weight each performance criterion according to its importance to the service user. Furthermore, some service criteria may be irrelevant to the service being requested, in which case no account will be taken by the service provider of these criteria in making a decision on which service provider to select for a particular job. Accordingly a weighting of zero can be given to either irrelevant performance criteria or performance criteria considered to be of no value to the service user.

A flow chart detailing an implementation of this process is contained in FIG. 2A. Initially a potential purchaser of the service makes a job request 1300 describing the job. The description is matched against each service provider's rules for performing a job (step 1310). If the service provider's performance criteria match they are automatically included (step 1320) in the list of potential service providers and included in the subsequent step of calculating cost effectiveness calculations (step 1400). Alternatively if the service provider's performance criteria does not match the job description (step 1330) the service provider is still given the opportunity to perform the work (step 1340). If the service provider wants the job (step 1350), he or she can make themselves available by submitting a suitable set of performance criteria to the system. This may be viewed as allowing the service provider to provide a tender for the job. If a suitable tender is submitted the service provider is included in subsequent cost effectiveness calculations. If the service provider is not interested in performing the job they can simply ignore the job request or state that they are not available (step 1360).

In the present exemplary embodiment the only suitability rating generated by the system is a cost effectiveness calculation (step 1400) based on the service provider's current rates. In order to make this calculation the system first looks in the database for the rates charged by each service provider. If the service provider offers “purchaser specific” rates for a particular service provider then these rates are used in the cost effectiveness calculation (step 1420). If job-type specific rates (step 1430) are offered then these rates are used. Each of the “purchaser specific” or “job type specific” rates defined by the service provider can include a set of rates 1421, 1431 for each element of the service provider, as well as a set of discounting rules or discounted rates 1422, 1432 for each element. If “purchaser specific” or “job type specific” rates are not offered by a service provider then their global rates are used to calculate the expected cost for the job. The expected cost for each service provider is calculated by adding the rates charged by the service provider for each element of the job. Once an estimated cost is calculated for each service provider, the service providers are ranked according to their cost effectiveness, and a list of potential service providers and their associated cost effectiveness rankings are supplied to the service user (step 1360). From this list the service user can select a service provider to do the job.

Returning to FIG. 2, a series of steps, marked generally as 1230, denotes a plurality of rankings performed by the selection system. Each criterion group, e.g. quality of product 2.6, and quality of resources 2.7, comprise weighted sums of comparisons made between service providers in respect of one or more performance criteria. Furthermore the relative importance of the criteria groups can be ranked or weighted by the service user and combined into a single quality ranking, provided with the list in step 2.4. Similarly, a comparison of performance criteria relating to cost can be compiled into one cost ranking. It may be the case that only the present rates of the service provider for performing a job are of interest to the service user. In this case the “average of past invoices” rating 2.9 and “predictions of future invoices” ratings 2.11 are weighted to a value of zero, so that the cost rating provided to the service user reflects only an estimate of the expected cost of the service based on the service provider's present rate.

A series of feedback steps marked generally as 1250 are also included in the process. In these steps the performance criteria of past jobs performed by a service provider are fed back into the database. These historical data are used in determining future ratings of the service provider.

Selected steps in FIG. 2 will now be explained in greater detail.

Step 2.2.—Service Provider Describes Services Performed

Initially service providers 24, 26 accesses a perform a registration web page on the web site 22 via their respective terminals and submit their performance criteria describing the attributes of the services that they are able to perform, or are willing to perform or supply; The information submitted includes information relating to each of the performance criteria defined in step 2.0.

This information is stored in the database 18 as a service provider profile and is compared to profiles of other service provider's in step 2.4.

Step 2.1—Submission of Service Requests by Selection System User

Service users 28, 30 can access a web page on the web site 22 via their respective terminals and submit a job request via the Internet 16 to the server 14. The request is a description of the requested service in terms of the user's desired performance criteria for the job. The information submitted with the job request is used, in part, to calculate the evaluation information associated with each service provider in step 2.4.

The application program 20 issues instructions to record the received job request data in the database 18 and to post it on a web page of the web site 22. The identity of the user requesting the service may or may not be posted on the website with such a request. In this embodiment requestor 28 remains anonymous.

Step 2.4—Prospective Service Users Review List of Available Service Providers

For each job request posted, the service user 28, 30 can download a web page from web site 22 which lists the potential service providers extracted from the database 18 by the selection system whose performance criteria correspond with the preferred performance criteria contained in the potential user's job request. Next to the list of service providers is a set of associated suitability rankings associated with each service provider.

To extract the list of potential service providers from the database the initially a set of essential performance characteristics, such as the type of job and location of the job are compared with the performance criteria of each service provider. If a service provider's profile does not match these functional performance criteria they are discarded as potential service providers and the calculations of the suitability ratings for the remaining service providers are continued.

If a service provider cannot or will not provide a particular element of a service, ie. the service provider's profile does not contain any specified essential performance characteristics the service provider is given the opportunity to upgrade or change their profile to redefine their performance characteristics in order to be included in a the list of potential service providers presented to the potential service user.

In this embodiment, the associated evaluation information includes a comparison of following classes of performance criteria:

a) Service capabilities;

b) Quality criteria (2.5);

c) Cost criteria (2.8); and

d) Timeliness of past performance (2.12).

Step 2.5, 2.8, 2.12—Calculation of Suitability Ratings

Calculation of each of suitability ratings for each service provider is comprised of a number of sub calculations.

Turning firstly to the calculation of a Quality rating for each of the service providers. The quality criteria in this example are made up of the two components of Resource Quality and Product Quality. In step 2.7 of FIG. 2 the Resource Quality of each service provider is compared with each other. To do this the selection system application calculates a weighted sum of the values stored in the database for each service provider in respect of the particular performance criteria of interest to the service user characteristic weighed by an importance rating of each criterion assigned by the service user. Similarly, a rating of the quality (Product Quality) of a service previously performed is assessed.

The Resource Quality (step 2.7) of a service provider (24,26) includes an evaluation of the service provider's equipment, personnel, management structure, intangibles, and business processes. In this example, the evaluated resources of an service provider may include such factors as the type and quality of the photographic equipment available to the investigators or the quality of the security systems installed in their offices, length of time in business etc.

If a particular performance resource quality criteria is important to a service user they are able to weight that resource quality criteria more heavily that a resource quality criteria of lesser importance.

The “Product Quality” criteria of step 2.6 includes a comparison of an average of the service user's evaluation ratings for jobs previously performed by each service provider using historical data stored in the database 18.

The Resource Quality and Product Quality are amalgamated into a single rating of the Quality of the service provider 2.5. Again the relative importance of Resource Quality 2.7 and Product Quality 2.6 to the service user can be accounted for by applying an appropriate weighting to a sum of the two ratings.

The estimated cost of a particular service is calculated in step 2.8 by summing weighted ratings in respect of the following criteria:

(a) a rating of the amounts previously charged similar jobs (step 2.9 Historical Costs);

(b) a calculation of the approximate cost of the job (step 2.10) using the current rates charged by the service provider for each element of the job; and

(c) discounted rates, special fee structures or a tender submitted by the service provider for providing the service (step 2.11).

Historical Costs (step 2.9) are calculated by determining the average hourly rate for the provision of similar services. For example, a company has historically charged an average of $100 per hour for services conducted in the suburb of Parramatta, NSW, then an estimate, based on this historical data of the cost for conducting a job of 12 hours duration in Parramatta is $1200. The historical costs of all potential service providers can be compared and service providers ranked accordingly.

In step 2.10 the selection system estimates the cost of performing the job for each service provider and generates a relative measure of cost effectiveness based on this calculation. As discussed above the job to be performed has been described in terms of the elements which must be performed to do the job, and each service provider profile has a cost stored in their service provider profile in the database for each service element that they are able to perform. Therefore, in order to calculate the estimated cost for each service provider the cost of each of the elements which make up the job can simply be added up.

Travel is one element of many services for which a fee may be charged. In some industries travel costs may be key factor in determining which service provider is the most cost effective for doing a job. In order to calculate the travel cost for a service provider the system calculates the distance between the job location and the nearest bill-out location for each service provider then multiplies this by the service provider's cost per kilometre charge rate. The time component for travel is also calculated by multiplying the expected travel time by the service provider's cost per hour for travel. The time and distance components are added together to calculate a total expected travel cost which can be added with the cost of other elements of the service to determine the total expected cost for performing the job.

Service providers are able to set up their user profile to include different cost structures for different service users, or set up rules for calculating the cost of each service element. Thus the service providers can offer discounts either by service provider, by the amount of work received, or by geographical location or other criteria that they specify.

In relation to the timeliness criteria (Step 2.12), the selection system user (28,30) may review evaluation information from other service users as to the timeliness of jobs previously performed by the service provider.

Step 2.13—Service Provider Chosen and Retained

In step 2.4 the application program 20 compiles a webpage 22 that is accessible by the service user who has made a request for service, which sets out the evaluation information for all potential service providers i.e. those service providers able to perform the service.

After considering the list of suitability ratings generated from each service provider's quality criteria (step 2.5), the cost criteria (step 2.8), and the timeliness criteria in (step 2.12), the service user (28,30) can select the service provider who has the most desirable criteria to perform the job according to the selection system user's own preferences.

The application program can also calculate an amalgamation of these criteria into a single rating, which can provided to the service user (28,30). The service user is permitted to vary the amalgamated criteria, by weighting the importance each particular criterion.

On this basis a service provider can be selected and retained.

Step 2.15 Service Performed

During performance of a job the service providers (24,26) receive feedback from their service users (28,30). In addition, the service users (28,30) or, optionally, the service providers (24,26) can vary the service criteria for the job during the course of the job due to changing circumstances.

Step 2.16 Service Completed and Billed

After completion of the job, the service provider's (24,26) invoice is presented to the service user (28,30). The service user or the service provider enters the amount of the invoice into the system using a form on a web page on the website 22. The data from this form is stored in the database 18 as a part of the service provider's profile, and can be used to determine the Historical Costs of services performed by the service provider.

Optionally, the feedback supplied can include an evaluation by the service user (28,30) of the reasonableness of the invoice amount given the job performed which can be stored as a part of a provider's profile.

Step 2.17—Service Analysis

Upon completion of the job the service user (28,30) can evaluate the job performed by the service provider, by evaluating the Product Quality and/or the timeliness of the service. Submission of the evaluation is completed by filling in a form located on a web page of the web site 22. This information is sent to the server 14 and recorded in the database 18 as part of the service provider's profile and used for calculating future evaluation information for the service provider. The evaluation information can also be used by other prospective service users (28,30) in evaluating the service providers (24,26) as described above.

Step 2.3.—Service Providers Review List of Service Requests

In most instances the system functions in an almost instantaneous manner with prospective service users selecting a service provider immediately upon being provided with a set of potential service providers and associated suitability ratings. However in some cases, jobs will not be allocated to a service provider immediately in which case, a service provider 24, 26 can download a web page from website 22 in which a list of service user requests are posted. The user requests are comprised of a list of the desirable performance criteria that are required satisfy the service user.

When an unallocated job exists a service provider is given the opportunity to amend their service profile to discount their services or to make themselves eligible to do a job they otherwise would be unqualified to do. For example a service provider may initially state that they only work within a 50 kilometre radius from their offices. However, a job may be pending which is only a short way beyond that limit. If the service provider wishes to be eligible to do this work they can amend their profile to make themselves eligible, and thus become a potential service provider. A discounting process may also be included in the system whereby a “once-off” discount can be offered to increase an investigator's chance to be chosen for a job.

Step 2.14—Feedback to Service Providers

Each of the service providers can access yet another web page on the web site 22 and view information on the performance criteria of the other service providers and use this information in setting their own profile, for example, by discounting their rates for a particular job.

A preferred implementation of the system and method of the first embodiment will now be described with specific reference to a selection system used by an investigation company for selecting an investigator to perform an investigation. It should be noted that in describing the preferred embodiments, the description of a selection system choosing an investigator is for the purposes of description only and is not intended to limit the scope of the invention. The invention can extend to the provision of services and/or associated goods generally including, but not limited to, legal services, employment services, graphic design services, telecommunications services, webhosting services etc.

In this embodiment, the service user (e.g. 28 of FIG. 1) is an insurance company, which requires the services of an investigation company (e.g. Service Provider 24 or 26 of FIG. 1) to investigate whether claims made by an insurance claimant are legitimate.

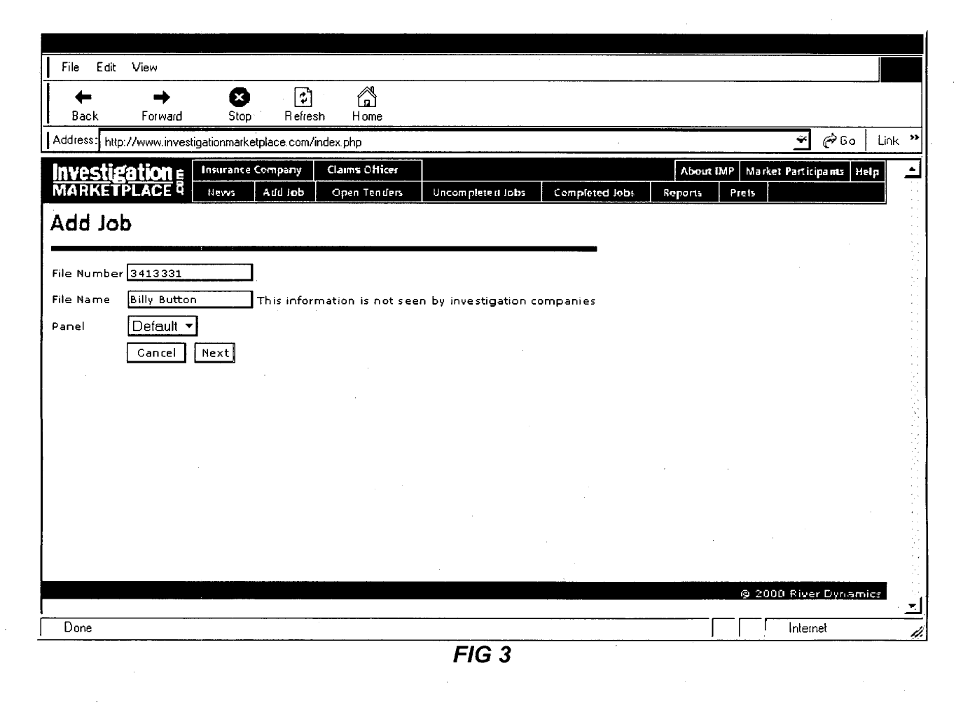

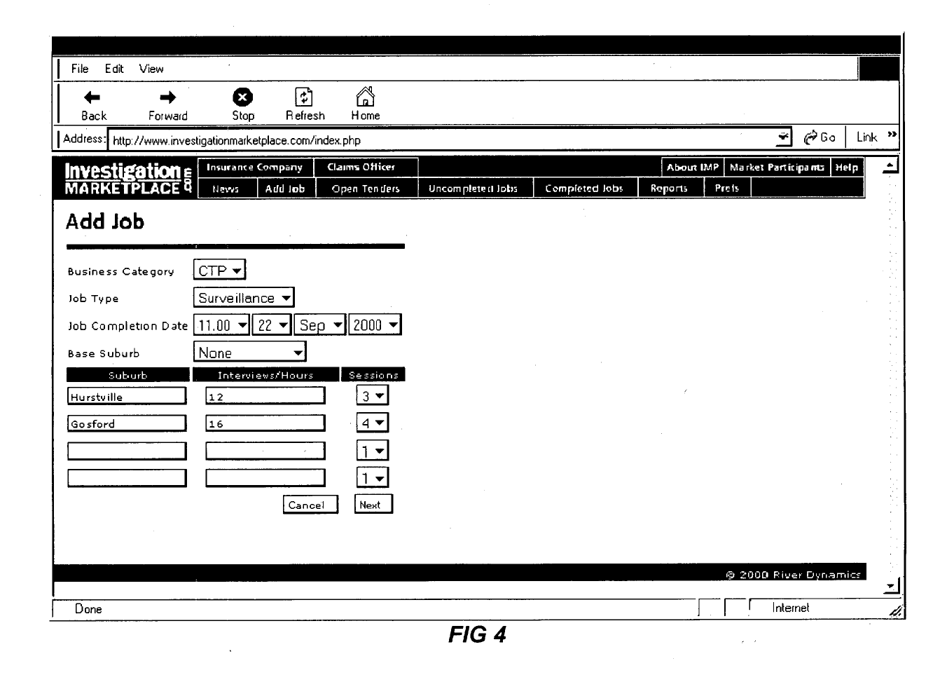

With reference to the system of FIGS. 1 and 2, the insurance company posts a notice on a web site 22 via the server 14 (Step 2.1) requesting an investigation service (“investigation Request”). Turning to FIGS. 3, 4 and 5, the insurance company 28 enters an internal reference ‘File number’, ‘File Name’ into the form shown on the screen in FIG. 3. These details allow the insurance company to track the job through the system. The application program 20 then generates the virtual form shown in FIG. 4 and the claims officer of the insurance company 28 enters data in the following fields:

| | |
|---|---|
| Job Type: | ‘Surveillance;’; |
| Job Completion Date: | ‘11:00, 22 Sep. 2000’ |
| Base Suburb: | ‘None’ |
| Suburb & Interview Hours: | ‘Hurstville = 12 hrs’; ‘Gosford’ = 16 hrs |

Each of the fields comprise performance criterion, as described above in relation to step 2.0 above. The “Job Type” and “Suburb & Interview Hours” fields are performance criteria which must be matched by as service provider if they are to be eligible to perform the service. The ‘Base Suburb’ field permits those investigation companies to nominate the suburb that they want to the investigation billed from. The Suburb & Interview Hours field relates to the suburbs in which the investigation has to be conducted, and the number of hours or the estimated number of hours the insurance company wants spent on the job.

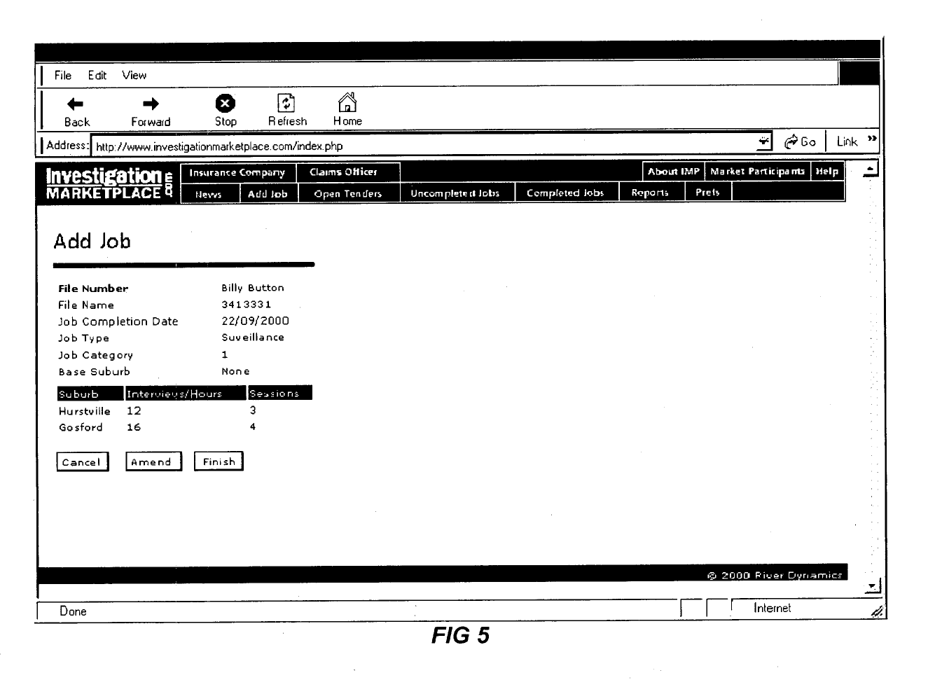

Once this information has been completed by an Officer of the insurance company 28, and submitted via the Internet 16 to the database 18, the application program then generates the screen shown in FIG. 5. This screen allows the user to review the job request and possibly amend it, before it is posted for review by investigation companies (eg. 24,26).

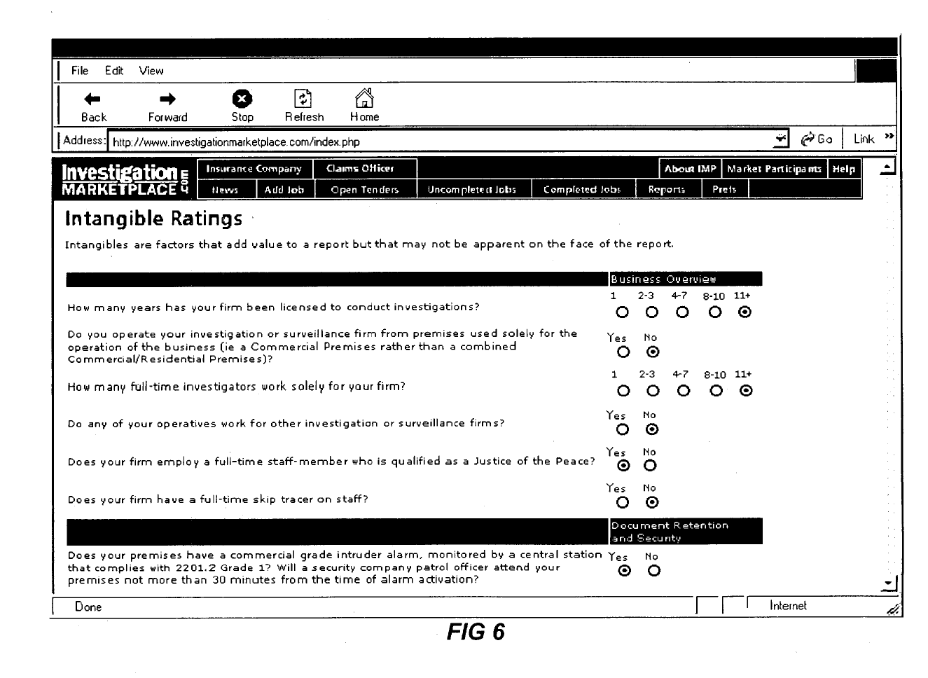

As described above, each investigation company using the selection system must enter their profile, ie. their service attributes in terms of the performance criteria, and their contact details into the selection system database 18. In order to enter their performance criteria into the database 18 the investigation companies (24, 26) list their resources and other attributes using the online form shown in FIG. 6. These details are stored in database 18 are used by the selection system to rank the investigation companies in terms of suitability for each service request.

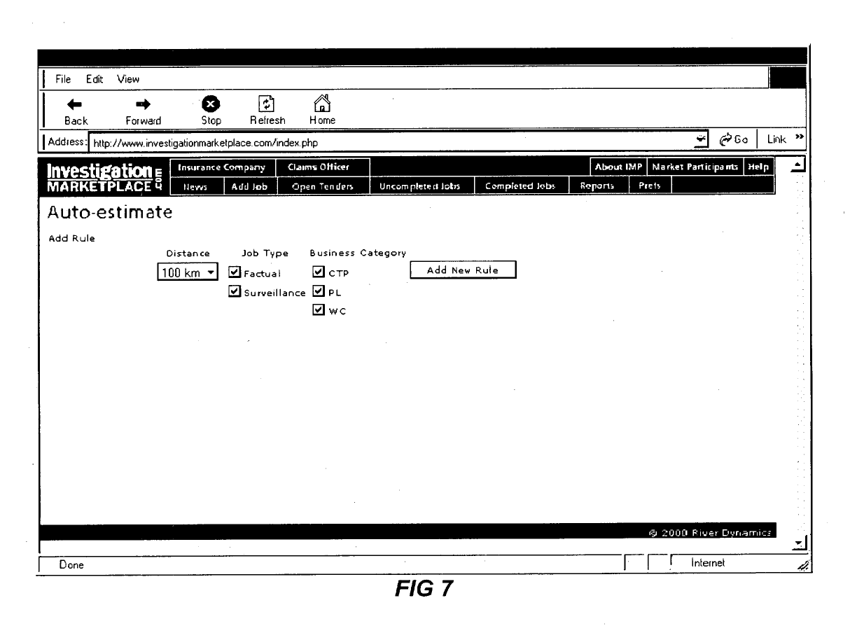

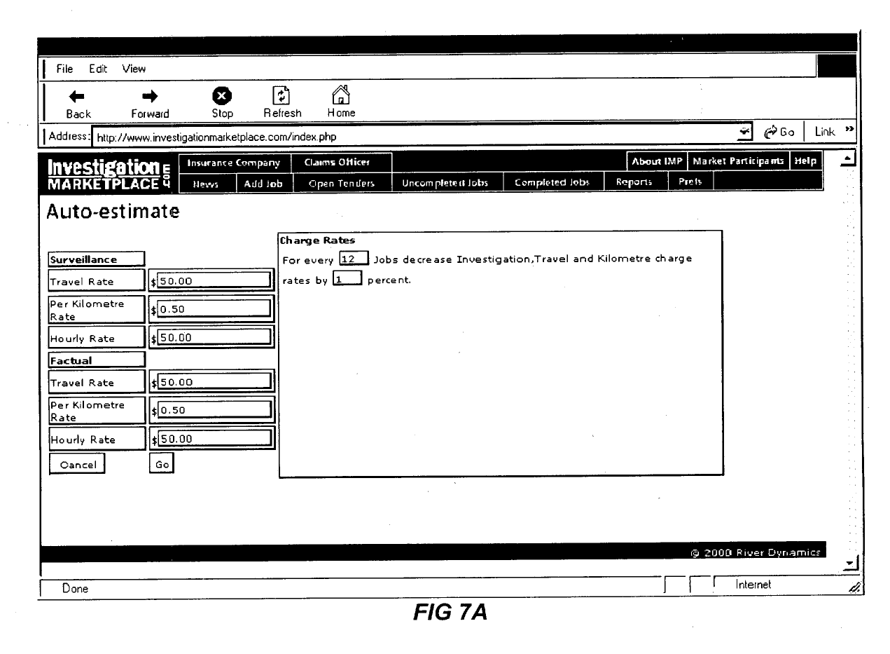

Furthermore they enter functional performance criteria as shown FIG. 7. In this embodiment, the investigation company 26 states that it is able to conduct Surveillance or Factual investigations for CTP, Workers Compensation or Public Liability matters within 100 kilometres of its bill-out suburb. The bill-out suburb is the suburb from which the investigation company bills its travel costs. Due to the nature of insurance investigation, insofar as that investigators are often based in their personal residences rather than an office, if an investigation company has numerous investigators, the investigator will have numerous bill out suburbs. In this embodiment, the Application Program 20 calculates the closest bill-out suburb for every investigation company for each investigation. Since travel costs often represent a significant proportion of the total cost of an investigation such a system generally results in the lowest cost outcomes for each job being presented to the service requester.

Cost criteria are also stored in the database 18 in the form of the rates charged by the investigation companies (24,26) for each element of the services performed.

In a particularly sophisticated embodiment a different profile can be used by a service provider depending on the identity of the service user. In this way special discounts or equipment can be offered to selected service users in order to increase the likelihood of selection for a job. In this embodiment, if the investigation companies (24,26) do not have personalised rates negotiated with the insurance companies (28,30), then their standard rates stored in database 18, are used in the calculations of the cost of the investigations for the insurance company.

The display of FIG. 7A illustrates to an agent of an investigation company the input fields for each of the elements of an investigation job. The elements of ‘surveillance’ and ‘factual’ investigation work for which cost criteria exist are:

(a) travel rate;

(b) per kilometre rate;

(c) hourly rate; and

There are also two fields for varying the costs as shown in FIG. 7A. These can be used to specify discounts for a particular insurance company, or amount of work.

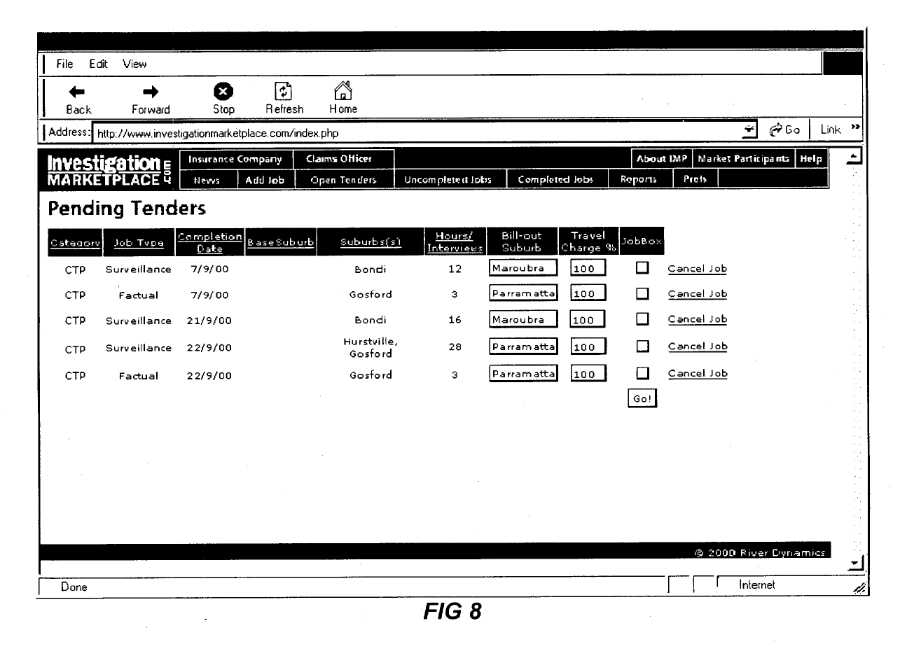

In order to alert the investigation company to jobs on offer which the investigation company is qualified to perform, a page as shown in FIG. 8 is generated. The investigation companies (24,26) can view this web page that displays a list generated from the database 18 of all investigation requests that meet the functional criteria of the service provider. For example, if a job request is made by an insurance company (28, 30), for work in a particular locality and the investigation company is not prepared to conduct work in that geographical area, then this job will not be displayed on the investigation company's display shown in FIG. 8.

The investigation requests are listed and according to criteria set by the investigation company. For example, they may be ranked by insurance company, estimated value of work, time for completion etc.

FIG. 8 lists all jobs currently in the system with the respective performance criteria required by the service user. A field also exists labelled “job box” which allow the investigation company agent to conveniently select any one of the jobs and submit a tender for investigation services. The investigation companies (24, 26) may offer to perform this work at a discounted rate. In this embodiment, the investigation companies (24, 26) offer discounts for receiving large quantities of investigation Requests or they may offer discounts for several investigations performed in the same geographical area. For example, an investigation company may offer to conduct an investigation at reduced travel cost in a particular geographical location if they are conducting other investigations in that area.

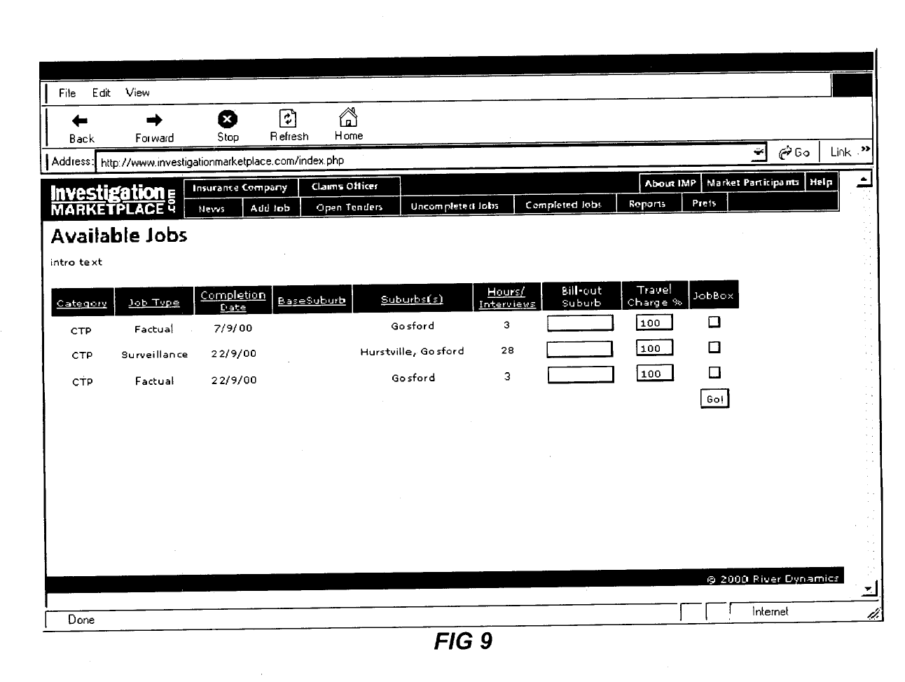

As shown in FIG. 9 the investigation companies (24, 26) may also view a list of investigation Requests that fall outside of their functional criteria. If an investigation company wishes to perform an investigation that falls outside of their functional criteria then they click on the “job box” link that indicates to the insurance company that placed the service request that the investigation company is available to perform this work. For example, by clicking on the “job box”, an investigation company may indicate that they are willing to perform an investigation in Gosford, NSW, even though it falls outside of their work criteria. Alternatively they may change their profile to include the new area in their service area.

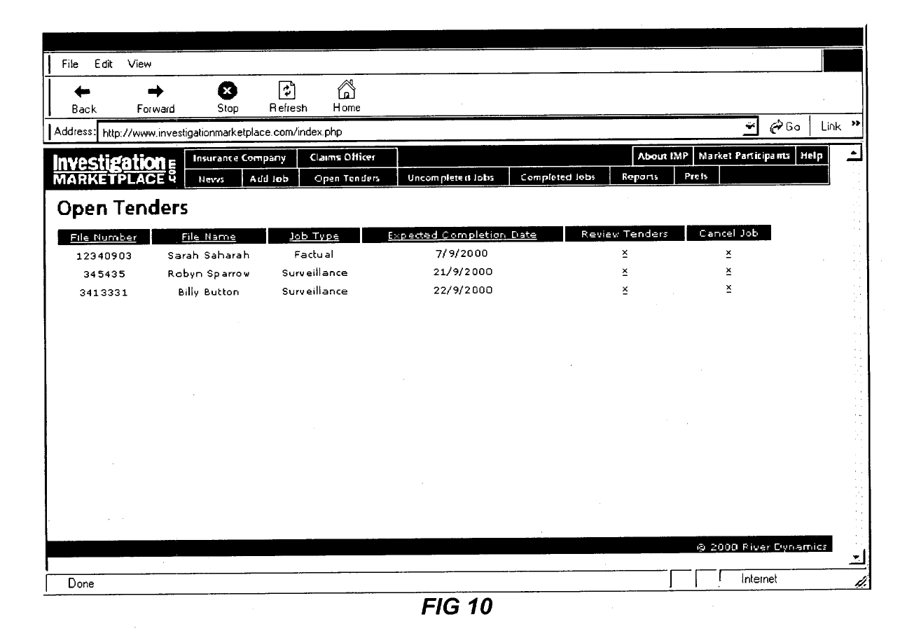

As shown in FIG. 10 the insurance companies (28, 30) may view a list of all Service Requests they have entered in to the database 18 via the web site 22 where they have not yet chosen an investigation company to perform the service. From this screen the insurance company can select a job and view each investigator's evaluation information for it.

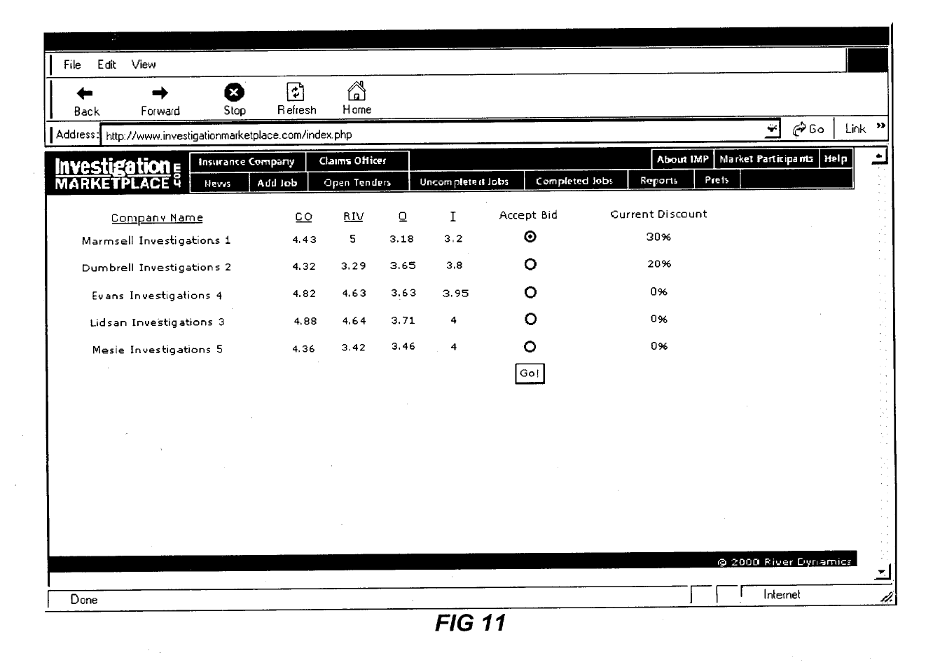

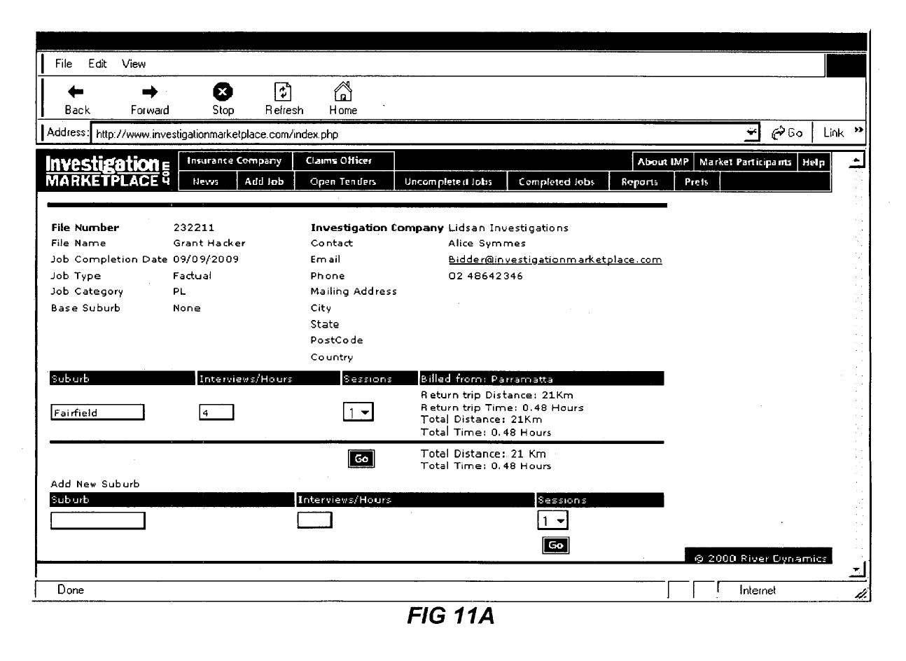

FIG. 11 shows an output for the system for the job request shown in FIGS. 4 and 5, and displays a list of potential service providers and their associated suitability ratings, as seen by a claims officer of an insurance company. The insurance company (28,30) is presented with a ranked list of all investigation companies (24, 26) who are available to perform that work (according to a comparison of the investigators functional performance criteria with the job request.)

The “T” rating shown in FIG. 11 is the timeliness rating for each of the investigation companies who are available to perform the investigation. The “Q” rating is the quality rating for each of the investigation companies. The “Q” rating is an amalgamation of the quality ratings of their previous work as rated by the insurance company making the request (28, 30), the resources rating for of the investigation companies.

An example of the calculation of each of the suitability ratings will now be described from data input in the job request of FIGS. 4 and 5.

Present Rates ‘RIV’

The RIV rating represents the relative cost effectiveness of the investigation companies. The RIV value is calculated based on the distance between the closest bill-out suburb for the investigation company and the site of the investigation. As described above the travel distance is multiplied by the investigation company's travel rate per kilometre and added to the expected travel time multiplied by the travel rate per hour. This calculation is added to the number of hours of investigation multiplied by hourly rate for investigation to estimate the cost of the job.

FIG. 11A shows the details of the distance and travel time for Lidsan investigations. The bill-out suburb for Lidsan investigations is Parramatta which is 21 kilometres and 0.48 hours return from Fairfield (the location of the job). Lidsan charges $0.50 per kilometre for travel and $50.00 per hour for travel time, giving a total travel charge of $34.50. Lidsan charges $50.00 per hour for investigation time. The investigation in this instance comprises 4 interviews in one session. Each interview is expected to take one hour, for a total interview cost of $200.00, resulting in a total cost of $234.50 for these aspects of the investigation.

This figure is compared to the estimated cost of the other investigators and ratings calculated. The RIV ratings received by the investigation companies and normalised to a value out of 5. As can be seen in FIG. 11, Marmsell investigations is the closest investigation company or has the least expensive rates and therefore receives a RIV rating of 5, with Lidsan investigations receiving the second best RIV at 4.64.

Quality ‘Q’

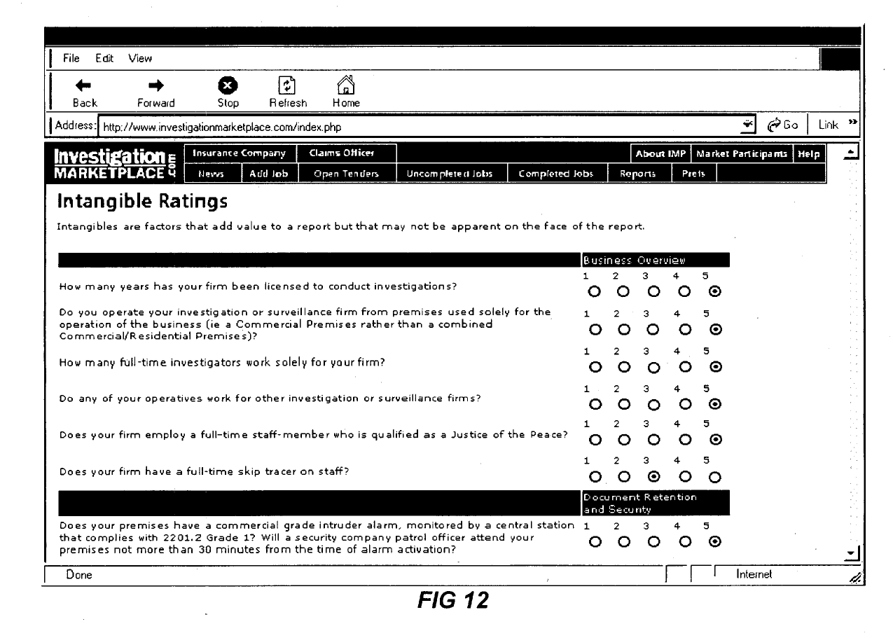

The quality rating is a combination rating covering the resources held by an investigation company (2.7), the insurance company's valuation of the resources, and the historical quality rating given by the insurance companies (2.6). In this embodiment, the ratings seen by the insurance companies for quality are an amalgamation of an investigation companies ratings given to their past work, and the resources of the investigation companies (24, 26). The insurance company rates the importance to them of the performance criteria relating to the resources possessed by the investigation companies by filling in the form shown in FIG. 12. It can be seen that each of the resource quality factors with the exception of one are rated of the same importance by this insurer.

The component of Q based on resources quality can be calculated using the following formula:

$$\frac{{\sum }_{i = 1}^{n} {Rating}_{i} \cdot {Criterion}_{i}}{5 \cdot n}$$

where Ratingᵢ is the importance rating of the “ith” quality criterion set by the insurer on a scale of 1 to 5, and, Criterionᵢ is the value for the “ith” quality criterion stored in the database for each the investigator, and n is the total number of quality criterion.

Timeliness ‘T’

The timeliness rating is calculated from a comparison of the historical ratings given by insurance companies for jobs performed by the investigation company.

Cost Quality Rating ‘CQ’

The CQ rating is a combination of the other ratings shown on FIG. 11.

To calculate CQ firstly, the RIV, Q and T are normalised to a value out of five as compared to all of the potential investigation companies available to perform the job to determine the Adjusted RIV, Adjusted Q and Adjusted T values.

The insurance company determines the relative weight that is to be given to each of the RIV, Q and T criteria by allocating an importance weighting. In the example shown in FIG. 11, the insurance company has rated each of the RIV, Q and T equally at 5 points. Thus the calculation for CQ is as follows:

CQ=((Adjusted T*5)+(Adjusted Q*5)+(Adjusted RIV*5))/15.

Due to normalisation of the T, Q and RIV values, the ‘Adjusted T’ for “Lisdan” in this instance is increased to 5. Similarly, the Adjusted Q rating is also 5. The RIV is already out of 5 (with Marmsell scoring 5) so normalisation has no effect on Lidsan's RIV. Applying the formula a CQ of 4.88 is calculated for Lidsan.

Returning to FIG. 11, the insurance company can choose an investigation company after reviewing the list of potential service providers and their associated suitability ratings (step 2.13) by clicking the appropriate “radio button” followed by the “GO” button. Upon selection, an email is sent to the investigation company informing them of their selection. If this meets with the approval of the investigation company then they accept the job by clicking on a link on the email. Detailed instructions relating to the job can then follow in due course via known communication means such as email, post, courier or the like.

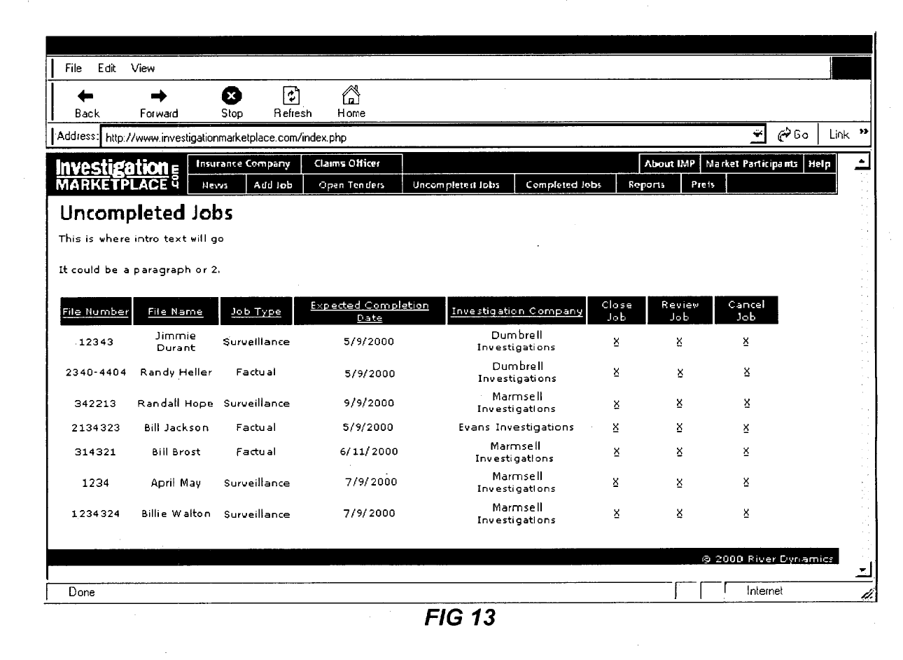

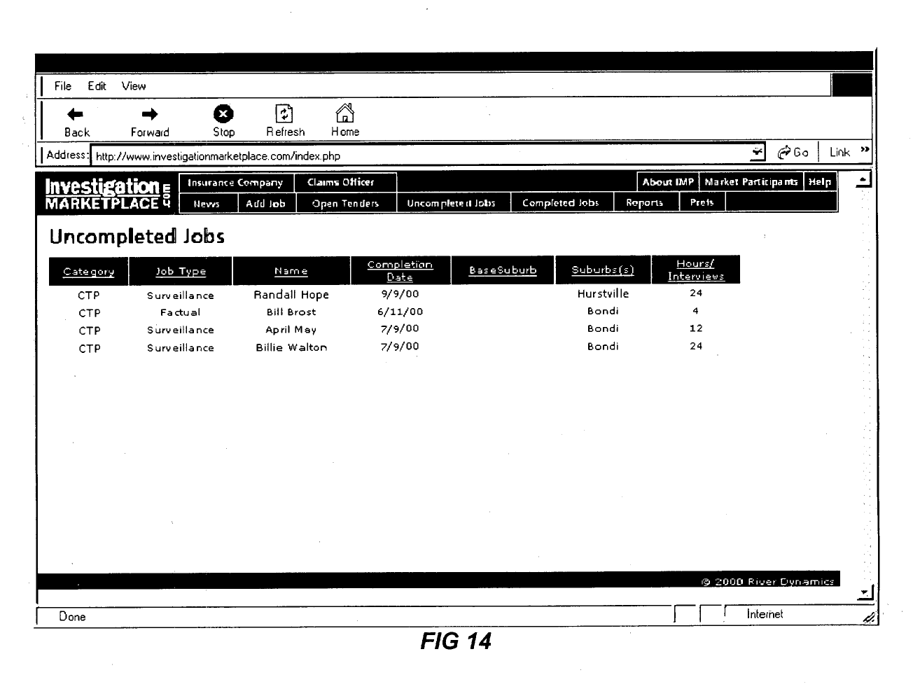

Upon the acceptance of the Service Request, the Service Request becomes an “Uncompleted Job” within the system. The insurance companies may view a list of Uncompleted Jobs by viewing a web page on the web site 22 that extracts from the database 18 all uncompleted jobs for that employee of the insurance companies as shown in FIG. 13. To facilitate the tracking of jobs an investigation companies can also view a list of all Uncompleted Jobs as shown in FIG. 14.

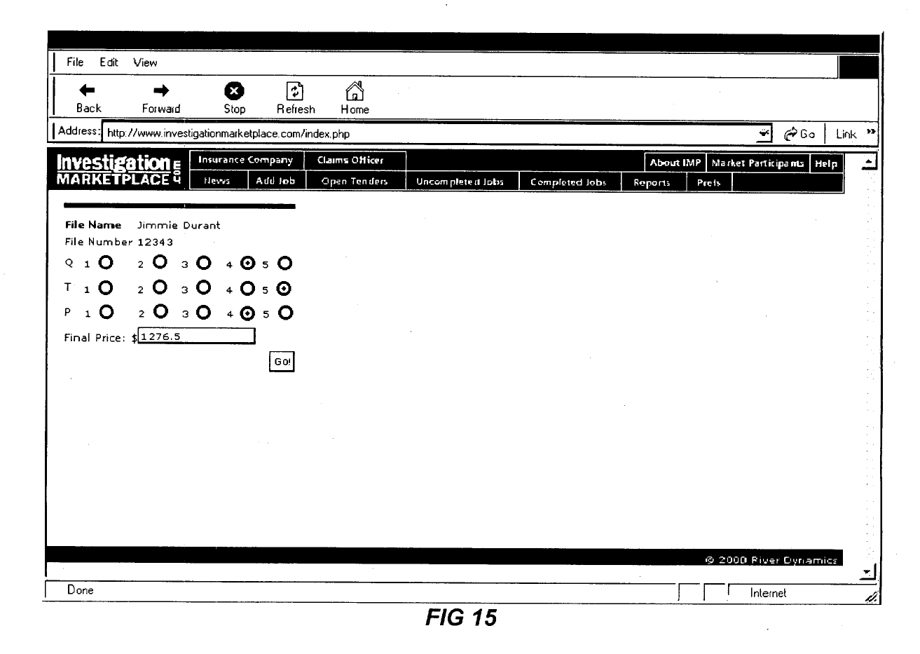

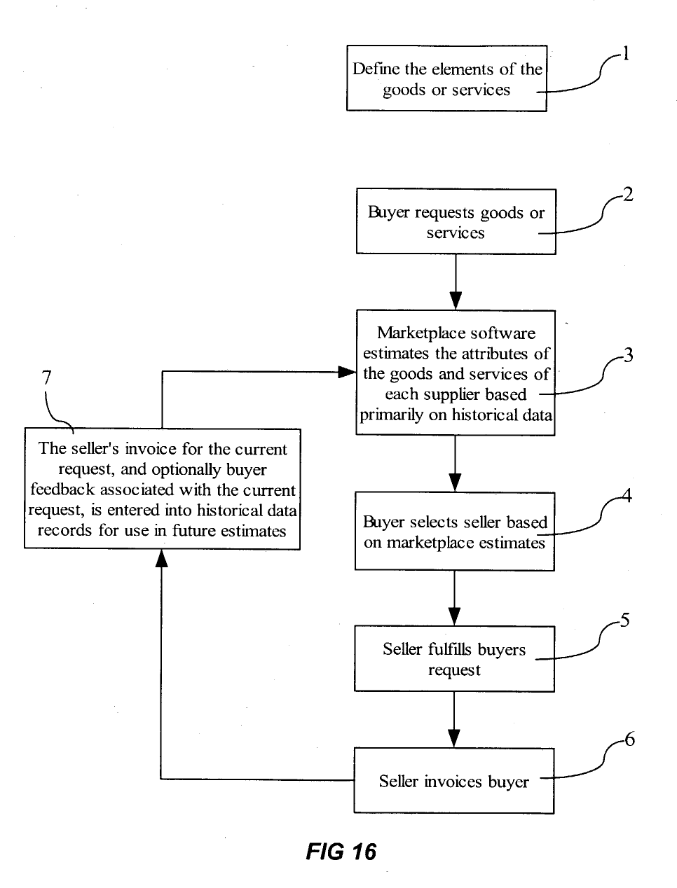

Upon submission of the report by the investigation company, the cost of the investigation is entered into the database 18 via a web page on the web server 22. Either the investigation company or the insurance company may do this. Turning to FIG. 15 the insurance company additionally rates the investigation company on the quality and timeliness of their report. This can be done in a number of ways using a number of performance criteria. As shown in FIG. 15 a single quality rating “Q” has been used as a performance criterion, as well as a timeliness rating “T” and a rating of the reasonableness of the cost “P” of the investigation.

It will be appreciated that because the insurance company ranks the set of quality criteria as described above, the present embodiment allows the insurance company to assess the service provided by the investigation company according to its own priorities. If the insurance company, being in this case the selection system user, wants to assign a higher value to an investigation company with at least 5 years experience to complete particular investigation services or some other quality, the embodiment described above is very useful.

Furthermore by allowing each of the RIV, Q and T ratings to be weighted when calculating the CQ rating the insurance company can obtain a single suitability rating with their own desired weighting having already been given to all of the performance criteria of the investigation companies.

Additionally, it should also be realised that in this embodiment, because the investigation company is provided with an opportunity to evaluate the services performed by the investigation company after completion of the service, this assists the insurance company in dynamically assessing the services of a multiplicity of investigation companies and thereby choose the most consistent service provider which is suited to its needs.

The system and method described above in connection with the first embodiment primarily uses the current rates charged by each service provider to estimate a cost effectiveness ranking for each service provider and allows the buyer to select a service provider based on this information. The inventors have found that such a system may be susceptible to manipulation by service providers who wish to win additional work. This can be done by a service provider inputting lower than market value rates into the system in order to obtain a more favourable cost effectiveness ranking. However, when it comes to the provision of the service the final invoiced cost of the job to the buyer may include the cost of extra items or service time in addition to that requested, surcharges etc. In such cases the predicted cost effectiveness of the service provider is not accurate.

A further embodiment of the present invention which aims to address this issue will now be described.

The inventors of the present system have surprisingly discovered that accurate and robust estimates of expected costs can be derived by effectively ignoring the current or quoted rates charged for services and/or associated goods by sellers. The present embodiment accordingly uses historical cost data, which represent the amounts invoiced for a group of previous transactions and the description of the services and/or goods requested or supplied in each of the previous transactions to estimate future costs for similar or identical services. The provision of services can clearly include the provision of associated goods and disbursements.

By making the selection process known to the supplier, the supplier is encouraged to charge each customer as competitively as possible in the knowledge that their current invoicing directly affects their future workflow. For the purchasers a marketplace operating on this principle is preferable as it encourages optimal competition and lower prices. Furthermore the present system is clearly preferable to receiving tenders or quotes, which are time consuming to review and are susceptible to manipulation by suppliers.

The present embodiment will be described in the context of the provision of insurance investigation services, more particularly in the context of the provision of 20 hours of surveillance of an insurance claimant. As will be appreciated by those skilled in the art the present invention is not limited to the provision of investigation services, but may be applied to the supply of services without limit. The services may or may not include a travel or delivery component.

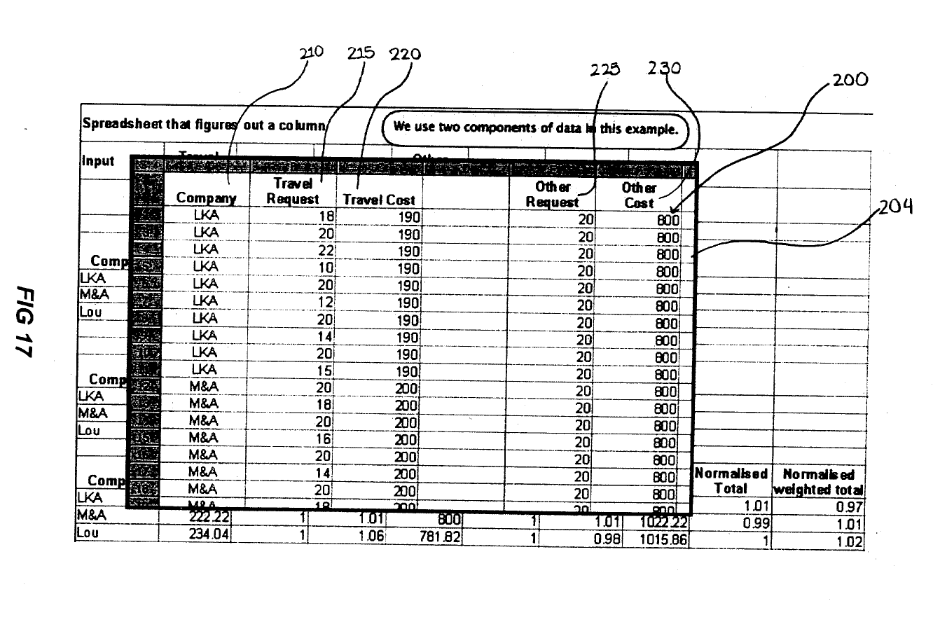

FIG. 17 outlines the steps in the present embodiment. As described above, in order to perform the method, the services and/or associated goods being traded in the marketplace must be defined. This is done in step 1 of the flowchart.

The services and/or associated goods are defined by a set of elements that make up the services and/or associated goods and optionally a set of qualitative performance attributes. The elements of the services and/or associated goods can be used by a buyer to describe a product or service they need. Each of the sellers or service providers in the market place are required to split their invoices for each job into their charges for each element, to enable historical data to be readily collected for each seller.

The qualitative performance attributes describe factors other than price which can affect the quality or kind of services and/or associated goods supplied by each seller, such as the quality or type of equipment and/or resources used to perform a service, or the qualifications or association memberships possessed by people performing the service. Historical quality or timeliness measures, such as the percentage of past jobs completed within a set deadline; and the level of satisfaction of previous service users with the supplier can also be used as qualitative performance attributes.

In the present example, where the service requested is an investigation service, two elements are used. The first element is travel, and the second element is an hourly rate for performing surveillance.

Once the services and/or associated goods being traded are defined in terms of their elements the buyer can place a request for services and/or associated goods, in step 2. The buyer's request is set out in terms of the quantity of each element which they desire. The buyer can also specify relative weighting's for each of the qualitative performance criteria if they wish to be presented with a comparable quality estimate for each of the service providers.

Optionally an importance weighting can be given to cost and quality criteria to allow the buyer to compare criteria of different types to one another. For example, if quality is twice as important to a buyer as price, then a final comparable desirability index can be generated in which the cost rating and quality ratings are weighted such that two-thirds of the final comparable indices for each seller are made up from a quality rating and one third from a cost-effectiveness rating.

Alternatively the comparable desirability index can be generated by using the quality rating as a multiplier which scales the comparable cost data. For example, each supplier's quality rating can be scaled into a multiplier between 1 and 1.5, with 1 being the highest quality and 1.5 the lowest quality. The remaining suppliers' quality multipliers can be scaled proportionally between these endpoints. The desirability index can then be calculated by multiplying the comparable cost estimate by the quality multiplier to generate a desirability index. Clearly the lower the desirability rating the more desirable the service provider is.

In step 3 the market-place software provides the buyer with a rating for each seller, reflecting their ability to fulfil the request. Typically this will be a cost effectiveness rating which is normalised to 1. A rating of 1 means a seller is of average price for the job, and a rating of 1.5 means that the seller is 50% more expensive than average. As will be appreciated by those skilled in the art other methods of presenting results enabling buyers to compare the relative cost an/or quality of the service providers can be used. For example, rather than normalising the cost estimates such that the average supplier is given a value of “1”, the lowest cost supplier can be given a rating of 1, with more expensive suppliers being rated grater than 1 eg. 1.1 can be given to a supplier who is 10% more expensive than the cheapest supplier.

As described above it has been discovered that accurate and robust cost effectiveness ratings can be based primarily, or solely, on historical data relating to previous invoices issued by a seller.

A normalised quality rating based on the qualitative performance attributes such as service quality, or timeliness, can also be derived from historical data, that reflects, inter alia, the satisfaction level of customers previously dealt with by the seller. The cost and quality ratings can then be combined according to the buyer's weightings, if it is desired to determine a final comparable rating for each seller.

In step 4 the buyer selects a seller, and in step 5 the seller supplies the services and/or associated goods requested to the buyer. The seller then, in step 6, invoices the buyer for the supply of the services and/or associated goods.

Finally, in step 7, the seller's invoiced amount for the current request is added to the dataset of historical data which can be used in for future predictions. The buyer can also rate the seller's quality or timeliness, for addition to the historical quality dataset.

FIG. 17 shows part of a data set 200 containing historical data for three investigation companies. Each row 204 represents one job requested by a buyer. The data contained in row 204 can alternatively be viewed as one invoice rendered by the seller.

The first column 210 of the data set designates the company issuing the invoice, and the second column represents the distance travelled by the company when performing an investigation. The distance travelled in each case may not be equal to the distance invoiced by the service provider for the job, rather it is calculated by the marketplace software. The distance is determined by calculating the distance between the service provider nearest operating location and the location at which the surveillance job is performed. Thus in essence this is a theoretical distance requested by the buyer and may not represent the actual distance travelled by the service provider in performing the job. The next column 220 contains the amount, in dollars, charged by the service provider for the travel performed in each job. Next column 225 contains the number of units of surveillance requested by the buyer in each job. Again, this number is not representative of the number of hours billed by the company in each job but is the actual number of hours requested by the buyer. Final column 230 contains the actual amount charged by the company for performing surveillance in each job. If additional services are requested by the buyer, additional columns of information may be contained in the data set. For example, if a cost is charged for writing a report, or providing photographs to the buyer, or administrative charges are levied then the invoice can be broken down into additional elements, and data collected for each of these extra components. Again these additional service components would be represented as one column representing the number of units of each additional service requested by the buyer and the total charged for the item in each particular job. Alternatively the administrative or photographic costs can be added into the surveillance costs a single an element.

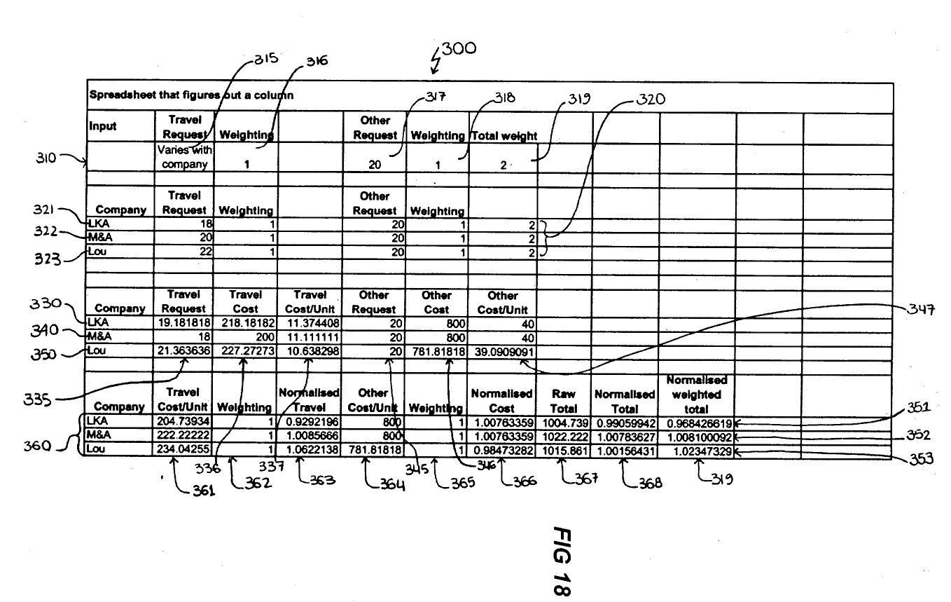

FIG. 18 shows the results of the various calculations performed by the market place software. The first row of the spreadsheet 300 sets out the request input into the system by the buyer. In this case the request is for 20 hours of surveillance performed at a particular location. This is represented in row 310 by the travel request in cell 315. The travel request is of variable length depending on which company is engaged as shown in cell 315. Cell 317 represents a request for 20 units (each unit being an hour) of surveillance. Each component of the service can be weighted to reflect the importance of it to the buyer. As all of the values in this request are monetary values and cost effectiveness is the desired suitability measure the travel cost is weighted equally with the surveillance cost. This is represented by the value 1 being placed in cells 316 and 318. Cell 319 represents the aggregate value of all of the weightings of the components on the service requested by the buyer.

The service request in spreadsheet 300 is also displayed in a form which includes the travel distance required for each of the service providers. In this instance the 3 service providers, LKA, M&A, and Lou (321, 322 and 323 respectively) each have to travel a different distance to perform the job. It can be seen that by looking at the values in row 321 LKA must travel 18 km to perform the job, M&A must travel 20 km (cell 322), Lou must travel 22 km (cell 322). The other values contained in these rows do not vary between the service providers, and thus are identical to that shown in the request row 310.

Rows 330, 340 and 350 of the spreadsheet 300 show a series of calculated values representing the costs historically charged by each of the service providers for the performance of surveillance jobs in the past. For each of the service providers the value contained in column 335 represents the average travel distance requested in past jobs. The value in column 336 represents the average travel cost which each service provider has invoiced in the past. These values are derived from the actual values invoiced by the service provider. The values in column 337 are derived by dividing the average invoiced travel cost by the average requested travel distance for each service provider, to determine an average travel cost per requested kilometre of travel. It can be seen that in the past LKA on average has been requested to travel 19.18 km for each job which they have performed and on average has invoiced their client $218.18 for travel giving an average cost per requested kilometre of $11.37. From row 340 can be seen that M&A's average travel request is 18 km and their average travel cost $200 giving rise to an average cost per requested kilometre of $11.11. Lou on average has been requested to travel 21.36 km per job and has charged $227.27 on average per invoice for the travel component in previous jobs. Thus Lou's average travel cost is $10.64 per requested kilometre of travel.

In the present embodiment the cost per unit for each component of the invoice is calculated from the amounts invoiced on previous jobs, and the number of units requested by the buyer in previous jobs. This is distinct from using the number of units of service delivered by the service provider. Thus, service providers who habitually over-service, by providing more units of a particular good or service than requested, or who are inefficient and require additional time or travel to perform a job, are shown up by the system being more expensive since the number of units for which they issue an invoice is greater than the requested number of units. This ability to take into account the work practices of goods and service providers when determining their average historical cost also provides advantages for more efficient or cheaper goods and service providers. An example of this can readily be seen in terms of the travel component of a job. If a service provider can perform the service with less than the predicted travel distance and does not “premium” their travel expenses to bring them into line with expectations, their average cost per unit of requested travel will decrease.

In alternative embodiments, particularly in industries where over-servicing is not a common problem or services tend to be provided on an on-going basis, ie service requests are not made for a fixed number of units, the number of units supplied may be used to determine the average cost per unit for a particular element of a service.

Turning now to columns 345, 346 and 347 of rows 330, 340 and 350, which show calculations to determine the average cost per requested unit for surveillance tasks. This is performed in a similar fashion to the travel cost. Column 345 displays the average number of surveillance hours requested on previous jobs performed by LKA, M&A and Lou respectively. In this example each of the suppliers, has on average, been requested to perform 20 hours of surveillance per job in the past. Column 346 shows the average cost invoiced to their clients in respect of the previous jobs performed by each service provider. On average both LKA and M&A have charged an average of $800 for 20 hours of surveillance whereas Lou has charged an average of $781.00 for 20 hours of surveillance in the past. Column 347 contains the average historical cost per unit of surveillance requested for each of the service providers. As can be seen by the value in row 350 in the past Lou has invoiced the lowest cost per requested unit of surveillance in the past.

As described as above in relation to travel cost, the cost per requested unit value derived for the surveillance component of this job reflects a comparison between the jobs requested in the past and the actual charges invoiced for these previous jobs. Thus if one of the service providers commonly suggested to their clients after 20 hours of requested surveillance was performed that an additional 10 hours of surveillance was needed to adequately complete the job and an additional amount was invoiced for these hours over and above the initial request this would be reflected as an increased cost per requested unit, rather than as an increase in the number of hours requested in a previous job.

In the present example the calculation of the cost per unit of requested services and/or associated goods has been calculated by averaging the invoiced cost for the most recent jobs performed by each service provider. However, other statistical methods and analysis can be performed to accurately predict for the invoiced cost per unit requested. For example, a weighted average of the value over the previous ten (or any desired sample size) jobs may be used for each service provider. The largest weighting can be given to the most recent job, with the weighting tapering off to the lowest weighting for the oldest job. By using a weighting system such as this, service providers are encouraged to think carefully when issuing each bill as they know that their most recent bill is the most important factor in them securing their next job.

The number of past jobs which are included in the data set may also be varied to tailor the system to a particular application. For example, in some industries where price fluctuates quickly it may be necessary to only use a small sample of past jobs for determining cost effectiveness. Furthermore, a different statistical value can be used rather than the average such as the median or geometric mean. Certain jobs or sales may even be removed from the sample set used, say the two most expensive and two least expensive jobs, or all jobs falling outside two standard deviations from the average.

In a particularly preferred embodiment, after each job is fulfilled and the invoice cost recorded, ie. the invoiced cost is added to the historical dataset, an optimisation routine can be used to calculate the weighting for historical data which would have resulted in the best cost estimate of the newly received invoice. This optimised weighting scheme can then be used to weight the updated historical data to estimate the cost effectiveness of the service providers in respect of the subsequent job requests.

The last group of rows 360 in spreadsheet 300 shows the final cost effectiveness calculations and predictions made by the marketplace software. Rows 351, 352 and 353 show the calculated values for LKA, M&A and Lou respectively. The first column of values shows an estimated travel cost for each of the companies for the performance of the current requested job. This is derived by multiplying the cost per requested unit of travel contained in column 337 by the distance which must be travelled by the company to fulfil the request made by the buyer. Thus, to derive the entry for LKA in column 361, 11.37 is multiplied by 18 to arrive at 204.74. Similar calculations are made for M&A and Lou.

In order to allow the travel costings to be compared to other cost effectiveness or qualitative performance criteria a normalised travel cost is derived. The normalised travel costs are derived by dividing the travel cost for each company by the average travel cost for all of the companies. Normalised travel costs for each of the three companies are shown in column 363. A company which has a travel cost equal to the average will end up with a normalised travel value of 1, whereas a company who is expected to charge 10% above average for this job will receive normalised travel value of 1.1. By performing this calculation it can be seen that M&A's normalised travel value is derived by dividing 222.22 by (204.74+222.22+234.04/3)=1.01.

An identical process is performed for estimating the surveillance cost for each service provider in columns 364 to 366. In this regard, the values of column 364 are derived by multiplying each company's average cost per surveillance unit (which is shown in column 347) by the number of surveillance units requested. It can be seen that both LKA and M&A are expected to charge $800 for the surveillance component whereas Lou is expected to charge $781.82. The weighting column 365 is also displayed for the surveillance component of the invoice.

Column 366 shows a normalised cost calculation for the surveillance component of the present job for each company. Again, this is calculated for each company by dividing the estimated cost of each company by the average estimated cost for all of the companies. It can be seen in this example that LKA and M&A are slightly above average cost, whereas Lou is slightly below average cost at 0.98 normalised surveillance value.

The next column 367 shows a total estimated cost for each of the service providers. This is simply calculated by adding the calculated travel cost to the calculated surveillance cost. A normalised total cost is also produced by the marketplace software and entered into the cells of column 368. The normalised total cost for each company is produced by dividing each company's total cost by the average total cost of all of the companies. Thus it can be seen that LKA is predicted to be the most cost effective with a predicted cost effectiveness of 1% lower than average, Lou is expected to be of average cost, having a normalised cost effectiveness value of 1 and M&A is expected to be 1% more expensive than the average service provider for performing this job.

The last column on this spreadsheet shows a normalised weighted total value for each service provider. The normalised weighted total shown in column 369 for each service provider is derived by performing a weighted sum of the normalised values of each of the components of the service invoice or other assessment criteria. In this particular example as travel cost and surveillance cost of the invoice are both in dollars, they have equal importance and are both weighted as 1 (as shown in cells 316 and 318 of the spreadsheet 300). Thus for each company the normalised travel value is added to the normalised cost value and divided by 2, being the total value of the weightings. Thus it can be seen that LKA's normalised weighted total is 0.97, M&A's normalised weighted total is 1.01 and Lou's normalised weighted total is 1.02.

The present embodiment also allows the job allocation practices of different buyers using the system to be compared. To do so it is advantageous to use a variation on the previously described normalisation process. If one person allocating jobs to service providers uses only a small subset of the possible service providers, for example because of geographical limitations or differences in supplier capabilities, the spread of cost estimates can be relatively small, for example, $900 for the cheapest supplier and $1000 for the most expensive. In comparison, a system users able to select suppliers from a large pool of suppliers has a better chance of having supplier with a wider range of historical costs, for example the cheapest estimate for a particular job may be as low $700 and the most expensive at $1300. The average cost of each of all suppliers for these jobs may both be $1000, but the buyer with the narrow supplier choice would show that they selected the supplier at rated. 9 ($900/$1000), while the buyer with the larger supplier choice would select the supplier at 0.7 ($700/$1000). A manager comparing the buyers would instinctively think that the later buyer is doing a better job of suppliers.

Thus, instead of comparing suppliers against the average cost supplier, the normalisation can be made against the most cost effective supplier. In this example each of the buyers would show up as having selected the supplier rated “1” eg. $700/$700=1 and $900/$900=1. Thus, each buyer has identified and selected the cheapest supplier, but using he former normalisation technique it is not readily possible to compare the decision-making process of the buyers.

Once the buyer selects a supplier and the supplier fulfils the service request, the invoice from the buyer, which is preferably split into the defined service elements can be added to the historical dataset. In a preferred embodiment the addition of invoices to the dataset is automated. In a particularly preferred embodiment the marketplace software is integrated with the billing and payment systems of both the buyers and sellers enabling invoices to be issued and historical cost data to be recorded automatically. A third embodiment of the present invention will now be described, again in the context of the provision of surveillance investigation services. This embodiment of the present invention provides the user with relative cost estimation for each of the potential sellers based on historical costs, and also provides a number of quality related comparable performance criteria which the potential service user may use to pick the most desirable seller.

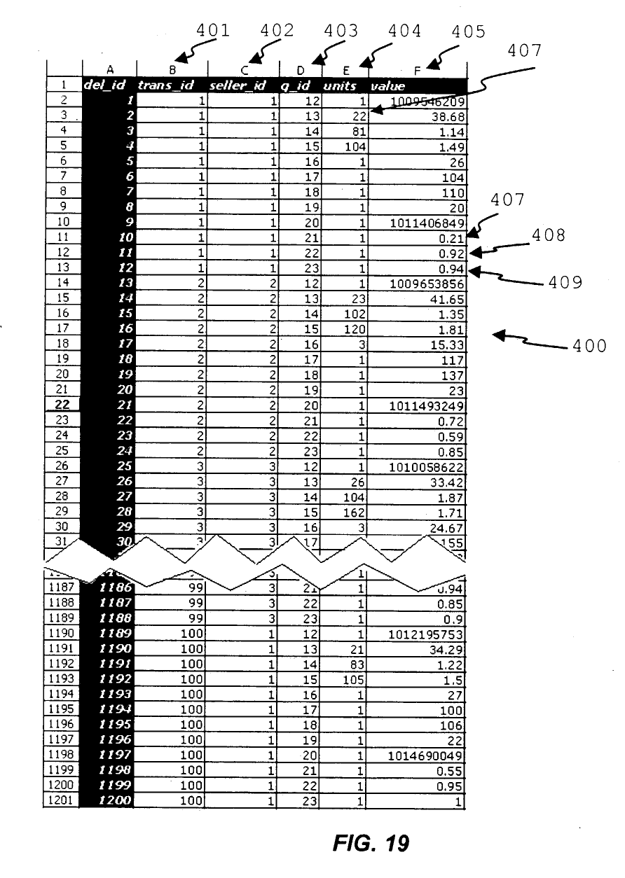

Referring first to FIG. 19, part of a typical database 400 of historical requests for surveillance investigations provided by three sellers for a hypothetical buyer is shown. The database is set out in spreadsheet form, and includes a transaction identification column 401 listing 100 sales transactions, a seller identification column 402 identifying the seller associated with each particular transaction, a question identification column 403, a number of units column 404 and a value per unit column 405.

In order to perform the historical cost and quality analysis properly, calculation of the historical costs of the group of three sellers must be performed. In the case of a surveillance investigation, this is achieved by breaking down each investigation, into elements e.g. on a cost per unit of time and distance basis. Each of the historical investigations is accordingly divided into a number of “questions”. Typical examples of such questions are listed below:

TABLE 1
Historical Questions

| | |
|---|---|
| Q12 | When was the investigation requested? |
| Q13 | Cost per hour of surveillance performed? |
| Q14 | Cost per kilometre travelled? |
| Q15 | Cost per hour of travelling? |
| Q16 | Cost of video tapes recorded? |
| Q17 | Administration costs? |
| Q18 | Other costs? |
| Q19 | Minutes of useful video tape recorded? |
| Q20 | Date investigation completed? |
| Q21 | % of successful observations on videotape |
| Q22 | % of elements of investigation completed satisfactorily |
| Q23 | Comprehensiveness of report, as a % |

The question numbers are filled out in the question identification column 403. For example, as is shown at 406, Q13 corresponds to 22 units and has a value of 38.6. Question 13 deals with the cost per hour of surveillance conducted on the particular job. In this case, the particular investigator of seller 1 performed 22 hours of surveillance and charged $38.60 per hour of surveillance, for a total cost of $851. Questions 14 and 15 also relate to costs per unit (hours and kilometres respectively), with the units column 404 detailing the actual number of kilometres and hours travelled. Questions 16-18 refer to other sundry costs, and questions 12 and 20 relates to the respective commencement and completion dates of the investigation. The data values given as answers to questions 12 and 20 are given in Unix time, namely in seconds elapsed as from Jan. 1, 1972.

The answers to quality assessment questions 21-23 have been normalised from percentages. By way of example, a value of 0.21 is provided at 407, which corresponds to a figure of 21% of successful observations being made on videotape in respect of the first transaction by seller 1. In the following question 22 shown at 408, the score of 0.92 corresponds to 92% of the investigation being completed satisfactorily, and at 409 the FIG. 0.94 indicates that the score of 94% was given to the comprehensiveness level of the report. It will be understood that, for ease of reference, the quality answers may be given upper and lower limits which are ultimately normalised. A permissible answer range may also be provided. In its most basic form, the answer range may include “yes” and “no” answers which are allocated a “one” and a “zero” respectively for converting multiple choice-type answers, intervening answers such as “sometimes”, “half the time” and “most of the time” may be “normalised” to equal, say, 0.25, 0.5 and 0.75 respectively. All of the quality questions are answered and entered on the buyer's side, with guidelines being provided to maintain a level of objectivity.

All of the historical cost data provided in the table of FIG. 19 is derived from sellers' historical invoices typically furnished by the buyers. The invoices are formatted and broken down in such a way that the data providing “answers” to the questions can be readily extracted. Ideally, there is a direct correlation between the questions and the per unit cost and no. of units presented in the invoices.

The data from each seller may be calculated according to various historical calculation formulae. The simplest formula is to take the mean average for each seller in respect of each question. A more sophisticated formula is to take the mean of, say, the past ten jobs for each seller. An even more sophisticated formula would be to calculate the average price for the past hundred jobs on a sliding exponential scale where the more recent jobs are weighted more heavily than the earlier jobs. One of the main driving factors is to ensure (and make it known to the sellers) that there is a direct correlation between recent invoicing pattern and work awarded.

Table 2 below sets out questions 8-12, which form part of the initial request put out by the buyer. Questions 8 and 9 are calculated using a separate software module which calculates the optimum times and distances between the various investigators and the investigation sites. The travel module takes the origin suburb(s) and the destination suburb(s) and return the shortest distance each seller would have to travel as described above.

TABLE 2
Request Questions

| | |
|---|---|
| Q8 | How many kilometres will the investigator travel? |
| Q9 | How long will the travel take? |
| Q10 | How many hours of surveillance would you like conducted? |
| Q11 | When are the instructions to be received? |

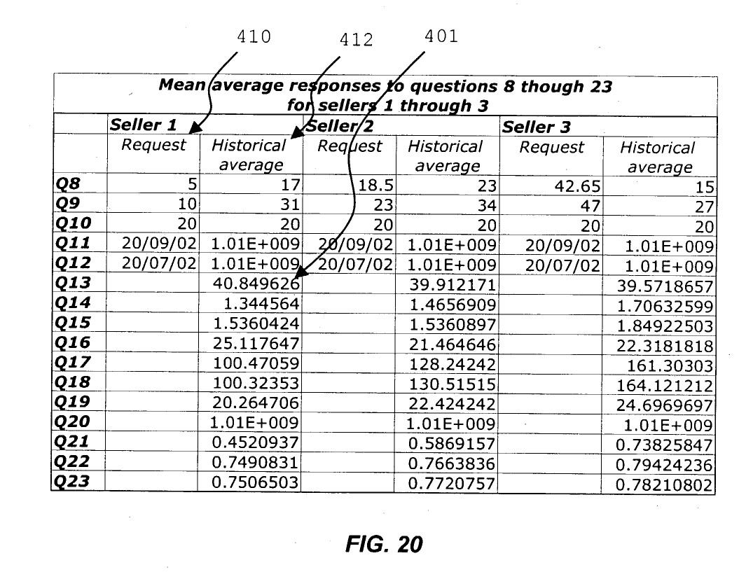

Referring now to FIG. 20, a table of the mean responses of three sellers in respect of each question is shown. The request column 410 in respect of seller one shows, at questions 8-10 respectively, the kilometres the investigator will travel (5), the travel time (10), and the respective hours of surveillance requested (20).

The historical average column 412 provides the historical averages for seller 1 in respect to questions 8-10 as calculated using the historical calculation formula. In the case of seller 1, the historical average kilometres travelled is given as 17. This is calculated by extracting from the units column 404 in FIG. 19. The units (in this case kilometres) corresponding to question 14 and using the historical calculation formula to derive the “average” of 17. Similarly, the average travel time of 31 hours is extracted from the database of FIG. 19, as is the average investigation time of 20 hours. The respective completion and commencement dates are similarly averaged. The average historical cost per unit of surveillance delivered by seller one is shown at 414. Sorting the data in this historical average fashion makes the calculation of expected surveillance costs quite easily by simply multiplying the number of requested surveillance hours (20) by the average historical cost per unit of surveillance (40.85).

Significant advantages of the system and method of the invention are realised when the groups of similar questions are combined into columns using the various formulae such as those set out in Table 3 below.

TABLE 3
Formulae for calculating each of the columns

| | |
|---|---|
| C1 | (Q8R*Q14H) + (Q9R*Q15H) + (Q10R*Q13H) + Q16 + Q |
| | 17 + Q18 |
| C2 | ((Q21H*3) + (Q22H*2) + (Q23H*1)) |
| C3 | Q20H − Q12H |
| C4 | 1*((C1 / C1Ave) − 1) + ((C2 / C2Ave) − 1) + - |
| | 1*((C3 / C3Ave) − 1) |

Column 1 indicates the expected cost for each seller for the particular job. The result is displayed as a dollar amount in Table 4 below for each seller. According to the formula, the column C1 displays the sum of the following five variables or combinations thereof: the requested kilometres in question 8 multiplied by the historical average cost per kilometre of question 14; the requested hours of travel of question 9 multiplied by the historical average cost per hour travelled of question 15; the requested hours of investigation of question 10 multiplied by the historical cost per hour of investigation of question 13; and the historical averages of questions 16-18.

TABLE 4
Column Calculation results

| | Seller 1 | Seller 2 | Seller 3 | Average | Stance |
|---|---|---|---|---|---|
| C1 | $1,064.99 | $1,140.91 | $1,298.87 | $1,168.26 | Goofy |
| C2 | 60.08% | 67.76% | 76.42% | 68.09% | Natural |
| C3 | 26.79 | 19.71 | 23.98 | 23.49 | Goofy |
| C4 | −0.17 | 0.18 | −0.01 | 0 | |

In column 2, each of the quality-related questions 21-23 is weighted by multiplying the question by a particular weighting factor. In the particular example, question 21 is heavily weighted by being multiplied by three, question 22 is moderately weighted by being multiplied by two, and question 21 is not weighted at all, and is thus multiplied by one, with the result being divided by six and displayed as a percentage. In column 3, the average is requested commencement date is subtracted from the average actual completion date of question 20 to get the average job duration in days.

When combining separate data types which represent different units, such as cost (currency) quality (percentage) and duration (days), each of the values needs to be normalised. The direction of normalisation depends on whether the most preferred value is the higher value, (as in the case of quality) or the lowest value (as is the case with cost). To combine cost and quality, the columns need to be normalised in different directions. For illustrative purposes, this is known as “stance”. When the best result for a column is the highest result (as is quality) this is known as “natural” stance, and when the best results are the lowest, (such as costs and duration) this is called the “goofy” stance (using skating/surfing terminology).

Column C4 of Table 4 includes a formula which effectively normalises and then combines the respective cost, quality and duration factors of columns 1 to 3 to arrive at a figure which quantifies the relative desirability of each seller. In the particular calculation, cost, time taken to complete the job and the combination of the above mentioned quality factors have all been given equal weightings. Naturally, this can be altered by the buyer simply by using the selected multiplier on each of the normalised figures.

In the particular example, the formula of C4 has the effect of normalising each of the column calculations of C1-C3 around zero. It will be noted that C4 has been calculated to yield a “natural” result, in which the highest figure indicates the preferred seller. This is achieved by using a multiplier of −1 in the case of C1 and C3, both of which have a “goofy” stance.

Assuming that seller 2 is selected, seller 2 is then notified and commences the job in accordance with the laid down parameters. On completion of the job seller 2 submits an invoice in a broken down format as described above which readily allows it to be entered into the database of FIG. 19. This can be achieved automatically, with manual entry being confined to quality questions 21-23.

The described method is thus implemented using an application which is typically in XML format. The data structure for a request is most naturally described using a schema and an XML document. Annexure A is a sample XML file showing a typical surveillance request. Annexure B is a schema which defines the valid request XML file. The contents and operation of this schema and the file of Annexure A will be clearly apparent to a normally skilled XML programmer.

It would be appreciated by a person skilled in the art that numerous variations and/or modifications may be made to the present invention as shown in the specific embodiments without departing from the spirit or scope of the invention as broadly described. For example, the present selection system for investigation services here described has been implemented on the Internet, but other networks configurations could also be used to implement the present invention. The present embodiments are therefore, to be considered in all respects to be illustrative and not restrictive.

Annexure A

XML file: request.xml

The data structure for a SmartAlloc request is most naturally described with a schema and xml document. The following is a sample XML file showing a surveillance request.

| 1. | <?xml version=“1.0” encoding=“UTF-8”?> |
|---|---|
| 2. | <request transactionId=“1” requestorId=“269” xmlns=“http://www.smartalloc.net/XMLSchema” |
| | xmlns:xsi=“http://www.w3.org/2001/XMLSchema-instance” |
| | xsi:schemaLocation=“http://www.smartalloc.net/XMLSchema |
| 3. | request.xsd”> |
| 4. | <sellers> |

| | |
|---|---|
| 5. | <seller id=“1”> |

| | |
|---|---|
| 6. | <questions> |

| 7. | <module qid=“8” type=“travel” returnType=“distance” calcMethod=“oneToMany” |
|---|---|
| | calcOperation=“sum”> |

| | |
|---|---|
| 8. | <origins> |

| | |
|---|---|
| 9. | <origin> |

| | |
|---|---|
| 10. | <address> |

| | |
|---|---|
| 11. | <street/> |
| 12. | <city>Liverpool</city> |
| 13. | <state>NSW</state> |
| 14. | <country>AU</country> |

| | |
|---|---|
| 15. | </address> |

| | |
|---|---|
| 16. | </origin> |
| 17. | <origin> |

| | |
|---|---|
| 18. | <address> |

| | |
|---|---|
| 19. | <street/> |
| 20. | <city>Sydney</city> |
| 21. | <state>NSW</state> |
| 22. | <country>AU</country> |

| | |
|---|---|
| 23. | </address> |

| | |
|---|---|
| 24. | </origin> |

| | |
|---|---|
| 25. | </origins> |
| 26. | <destinations> |

| | |
|---|---|
| 27. | <destination> |

| | |
|---|---|
| 28. | <address> |

| | |
|---|---|
| 29. | <street/> |
| 30. | <city>Bondi</city> |
| 31. | <state>NSW</state> |
| 32. | <country>AU</country> |

| | |
|---|---|
| 33. | </address> |

| | |
|---|---|
| 34. | </destination> |

| | |
|---|---|
| 35. | </destinations> |

| 36. | </module> |
|---|---|
| 37. | <module qid=“9” type=“travel” returnType=“travelTime” calcMethod=“oneToMany” |
| | calcOperation=“sum”> |

| | |
|---|---|
| 38. | <origins> |

| | |
|---|---|
| 39. | <origin> |

| | |
|---|---|
| 40. | <address> |

| | |
|---|---|
| 41. | <street/> |
| 42. | <city>Liverpool</city> |
| 43. | <state>NSW</state> |
| 44. | <country>AU</country> |

| | |
|---|---|
| 45. | </address> |

| | |
|---|---|
| 46. | </origin> |
| 47. | <origin> |

| | |
|---|---|
| 48. | <address> |

| | |
|---|---|
| 49. | <street/> |
| 50. | <city>Sydney</city> |
| 51. | <state>NSW</state> |
| 52. | <country>AU</country> |

| | |
|---|---|
| 53. | </address> |

| | |
|---|---|
| 54. | </origin> |

| | |
|---|---|
| 55. | </origins> |
| 56. | <destinations> |

| | |
|---|---|
| 57. | <destination> |

| | |
|---|---|
| 58. | <address> |

| | |
|---|---|
| 59. | <street/> |
| 60. | <city>Bondi</city> |
| 61. | <state>NSW</state> |
| 62. | <country>AU</country> |

| | |
|---|---|
| 63. | </address> |

| | |
|---|---|
| 64. | </destination> |

| | |
|---|---|
| 65. | </destinations> |

| | |
|---|---|
| 66. | </module> |
| 67. | <q id=“10” type=“number”>20</q> |
| 68. | <q id=“11” type=“dateTime”>2002-09-20T00:00:00+10:00</q> |
| 69. | <q id=“12” type=“dateTime”>2002-07-20T00:00:00+10:00</q> |

| | |
|---|---|
| 70. | </questions> |

| | |
|---|---|
| 71. | </seller> |
| 72. | <seller id=“2”> |

| | |
|---|---|
| 73. | <questions> |

| 74. | <module qid=“8” type=“travel” returnType=“distance” calcMethod=“oneToMany” |
|---|---|
| | calcOperation=“sum”> |

| | |
|---|---|
| 75. | <origins> |

| | |
|---|---|
| 76. | <origin> |

| | |
|---|---|
| 77. | <address> |

| | |
|---|---|
| 78. | <street/> |
| 79. | <city>Penrith</city> |
| 80. | <state>NSW</state> |
| 81. | <country>AU</country> |

| | |
|---|---|
| 82. | </address> |

| | |
|---|---|
| 83. | </origin> |
| 84. | <origin> |

| | |
|---|---|
| 85. | <address> |

| | |
|---|---|
| 86. | <street/> |
| 87. | <city>Chatswood</city> |
| 88. | <state>NSW</state> |
| 89. | <country>AU</country> |

| | |
|---|---|
| 90. | </address> |

| | |
|---|---|
| 91. | </origin> |

| | |
|---|---|
| 92. | </origins> |
| 93. | <destinations> |

| | |
|---|---|
| 94. | <destination> |

| | |
|---|---|
| 95. | <address> |

| | |
|---|---|
| 96. | <street/> |
| 97. | <city>Bondi</city> |
| 98. | <state>NSW</state> |
| 99. | <country>AU</country> |
| 100. | </address> |

| | |
|---|---|
| 101. | </destination> |

| | |
|---|---|
| 102. | </destinations> |

| 103. | </module> |
|---|---|
| 104. | <module qid=“9” type=“travel” returnType=“travelTime” calcMethod=“oneToMany” |
| | calcOperation=“sum”> |

| | |
|---|---|
| 105. | <origins> |

| | |
|---|---|
| 106. | <origin> |

| | |
|---|---|
| 107. | <address> |

| | |
|---|---|
| 108. | <street/> |
| 109. | <city>Penrith</city> |
| 110. | <state>NSW</state> |
| 111. | <country>AU</country> |

| | |
|---|---|
| 112. | </address> |

| | |
|---|---|
| 113. | </origin> |
| 114. | <origin> |

| | |
|---|---|
| 115. | <address> |

| | |
|---|---|
| 116. | <street/> |
| 117. | <city>Chatswood</city> |
| 118. | <state>NSW</state> |
| 119. | <country>AU</country> |

| | |
|---|---|
| 120. | </address> |

| | |
|---|---|
| 121. | </origin> |

| | |
|---|---|
| 122. | </origins> |
| 123. | <destinations> |

| | |
|---|---|
| 124. | <destination> |

| | |
|---|---|
| 125. | <address> |

| | |
|---|---|
| 126. | <street/> |
| 127. | <city>Bondi</city> |
| 128. | <state>NSW</state> |
| 129. | <country>AU</country> |

| | |
|---|---|
| 130. | </address> |

| | |
|---|---|
| 131. | </destination> |

| | |
|---|---|
| 132. | </destinations> |

| | |
|---|---|
| 133. | </module> |
| 134. | <q id=“10” type=“number”>20</q> |
| 135. | <q id=“11” type=“dateTime”>2002-09-20T00:00:00+10:00</q> |
| 136. | <q id=“12” type=“dateTime”>2002-07-20T00:00:00+10:00</q> |

| | |
|---|---|
| 137. | </questions> |

| | |
|---|---|
| 138. | </seller> |
| 139. | <seller id=“3”> |

| | |
|---|---|
| 140. | <questions> |

| 141. | <module qid=“8” type=“travel” returnType=“distance” calcMethod=“oneToMany” |
|---|---|
| | calcOperation=“sum”> |

| | |
|---|---|
| 142. | <origins> |

| | |
|---|---|
| 143. | <origin> |

| | |
|---|---|
| 144. | <address> |

| | |
|---|---|
| 145. | <street/> |
| 146. | <city>Parramatta</city> |
| 147. | <state>NSW</state> |
| 148. | <country>AU</country> |

| | |
|---|---|
| 149. | </address> |

| | |
|---|---|
| 150. | </origin> |
| 151. | <origin> |

| | |
|---|---|
| 152. | <address> |

| | |
|---|---|
| 153. | <street/> |
| 154. | <city>Blacktown</city> |
| 155. | <state>NSW</state> |
| 156. | <country>AU</country> |

| | |
|---|---|
| 157. | </address> |

| | |
|---|---|
| 158. | </origin> |

| | |
|---|---|
| 159. | </origins> |
| 160. | <destinations> |

| | |
|---|---|
| 161. | <destination> |

| | |
|---|---|
| 162. | <address> |

| | |
|---|---|
| 163. | <street/> |
| 164. | <city>Bondi</city> |
| 165. | <state>NSW</state> |
| 166. | <country>AU</country> |

| | |
|---|---|
| 167. | </address> |

| | |
|---|---|
| 168. | </destination> |

| | |
|---|---|
| 169. | </destinations> |

| 170. | </module> |
|---|---|
| 171. | <module qid=“9” type=“travel” return Type=“travelTime” calcMethod=“oneToMany” |
| | calcOperation=“sum”> |

| | |
|---|---|
| 172. | <origins> |

| | |
|---|---|
| 173. | <origin> |

| | |
|---|---|
| 174. | <address> |

| | |
|---|---|
| 175. | <street/> |
| 176. | <city>Parramatta</city> |
| 177. | <state>NSW</state> |
| 178. | <country>AU</country> |

| | |
|---|---|
| 179. | </address> |

| | |
|---|---|
| 180. | </origin> |
| 181. | <origin> |

| | |
|---|---|
| 182. | <address> |

| | |
|---|---|
| 183. | <street/> |
| 184. | <city>Blacktown</city> |
| 185. | <state>NSW</state> |
| 186. | <country>AU</country> |

| | |
|---|---|
| 187. | </address> |

| | |
|---|---|
| 188. | </origin> |

| | |
|---|---|
| 189. | </origins> |
| 190. | <destinations> |

| | |
|---|---|
| 191. | <destination> |

| | |
|---|---|
| 192. | <address> |

| | |
|---|---|
| 193. | <street/> |
| 194. | <city>Bondi</city> |
| 195. | <state>NSW</state> |
| 196. | <country>AU</country> |

| | |
|---|---|
| 197. | </address> |

| | |
|---|---|
| 198. | </destination> |

| | |
|---|---|
| 199. | </destinations> |

| | |
|---|---|
| 200. | </module> |
| 201. | <q id=“10” type=“number”>20</q> |
| 202. | <q id=“11” type=“dateTime”>2002-09-20T00:00:00+10:00</q> |
| 203. | <q id=“12” type=“dateTime”>2002-07-20T00:00:00+10:00</q> |

| | |
|---|---|
| 204. | </questions> |

| | |
|---|---|
| 205. | </seller> |

| | |
|---|---|
| 206. | </sellers> |
| 207. | <display> |

| | |
|---|---|
| 208. | <column id=“1” returnType=“all”> |

| | |
|---|---|
| 209. | <calc type=“sum”> |

| | |
|---|---|
| 210. | <calc type=“product”> |

| | |
|---|---|
| 211. | <q id=“13” type=“currency” limit=“10” orderBy=“asc” use=“historical”/> |
| 212. | <q id=“10” type=“number” limit=“10” orderBy=“asc” use=“requested”/> |

| | |
|---|---|
| 213. | </calc> |
| 214. | <calc type=“product”> |

| | |
|---|---|
| 215. | <q id=“14” type=“currency” limit=“10” orderBy=“asc” use=“historical”/> |
| 216. | <q id=“8” type=“number” limit=“10” orderBy=“asc” use=“requested”/> |

| | |
|---|---|
| 217. | </calc> |
| 218. | <calc type=“product”> |

| | |
|---|---|
| 219. | <q id=“15” type=“currency” limit=“10” orderBy=“asc” use=“historical”/> |
| 220. | <q id=“9” type=“number” limit=“10” orderBy=“asc” use=“requested”/> |

| | |
|---|---|
| 221. | </calc> |
| 222. | <q id=“16” type=“currency” limit=“10” orderBy=“asc” use=“historical”/> |
| 223. | <q id=“17” type=“currency” limit=“10” orderBy=“asc” use=“historical”/> |
| 224. | <q id=“18” type=“currency” limit=“10” orderBy=“asc” use=“historical”/> |

| | |
|---|---|
| 225. | </calc> |

| | |
|---|---|
| 226. | </column> |
| 227. | <column id=“2” returnType=“all”> |

| | |
|---|---|
| 228. | <calc type=“mean”> |

| | |
|---|---|
| 229. | <q id=“21” type=“percentage” limit=“10” orderBy=“asc” use=“historical”/> |
| 230. | <q id=“21” type=“percentage” limit=“10” orderBy=“asc” use=“historical”/> |
| 231. | <q id=“21” type=“percentage” limit=“10” orderBy=“asc” use=“historical”/> |
| 232. | <q id=“22” type=“percentage” limit=“10” orderBy=“asc” use=“historical”/> |
| 233. | <q id=“22” type=“percentage” limit=“10” orderBy=“asc” use=“historical”/> |
| 234. | <q id=“23” type=“percentage” limit=“10” orderBy=“asc” use=“historical”/> |

| | |
|---|---|
| 235. | </calc> |

| | |
|---|---|
| 236. | </column> |
| 237. | <column id=“3” returnType=“all”> |

| | |
|---|---|
| 238. | <calc type=“minus”> |

| | |
|---|---|
| 239. | <q id=“20” type=“dateTime” limit=“10” orderBy=“asc” use=“historical”/> |
| 240. | <q id=“12” type=“dateTime” limit=“10” orderBy=“asc” use=“historical”/> |

| | |
|---|---|
| 241. | </calc> |

| | |
|---|---|
| 242. | </column> |
| 243. | <column id=“4” returnType=“all”> |

| | |
|---|---|
| 244. | <calc type=“mean”> |

| | |
|---|---|
| 245. | <c id=“1” type=“norm” stance=“goofy”/> |
| 246. | <c id=“2” type=“norm” stance=“natural”/> |
| 247. | <c id=“3” type=“norm” stance=“goofy”/> |

| | |
|---|---|
| 248. | </calc> |

| | |
|---|---|
| 249. | </column> |

| | |
|---|---|
| 250. | </display> |

| | |
|---|---|
| 251. | </request> |

Annexure B

XML Schema: request.xsd

The following schema defines a valid request.xml file:

| 1. | <?xml version=“1.0” encoding=“UTF-8”?> |
|---|---|
| 2. | <!-- edited with XML Spy v4.4 U (http://www.xmlspy.com) by doug hudgeon (keen collective) --> |
| 3. | <xs:schema targetNamespace=http://www.smartalloc.net/XMLSchema”> |
| | xmlns:small=“http://www.smartalloc.net/XMLSchema” xmlns:xs=http://www.w3.org/2001/XMLSchema”> |
| | elementFormDefault=“qualified” attributeFormDefault=“unqualified”> |
| 4. | <xs:element name=“request”> |

| | |
|---|---|
| 5. | <xs:annotation> |

| 6. | <xs:documentation>Request that comes from the front end to the SmartAlloc backend for display of |
|---|---|
| | sellers</xs:documentation> |

| | |
|---|---|
| 7. | </xs:annotation> |
| 8. | <xs:complexType> |

| | |
|---|---|
| 9. | <xs:complexContent> |

| | |
|---|---|
| 10. | <xs:extension base=“small:requestType”/> |

| | |
|---|---|
| 11. | </xs:complexContent> |

| | |
|---|---|
| 12. | </xs:complexType> |

| | |
|---|---|
| 13. | </xs:element> |
| 14. | <xs:complexType name=“calcType”> |

| | |
|---|---|
| 15. | <xs:sequence minOccurs=“0”> |

| | |
|---|---|
| 16. | <xs:annotation> |

| 17. | <xs:documentation>The calculation can be a question in the request (such as 20 hours of surveillance) |
|---|---|
| | mulitplied by the average cost of each seller for each hour of surveillance they conducted in the |
| | past.</xs:documentation> |

| | |
|---|---|
| 18. | </xs:annotation> |
| 19. | <xs:element name=“calc” type=“small:calcType” minOccurs=“0” maxOccurs=“unbounded”/> |
| 20. | <xs:element name=“q” type=“small:qType” minOccurs=“0” maxOccurs=“unbounded”> |

| | |
|---|---|
| 21. | <xs:annotation> |

| 22. | <xs:documentation>Questions can be given additional weighting by including them more than once |
|---|---|
| | in the column.</xs:documentation> |

| | |
|---|---|
| 23. | </xs:annotation> |

| | |
|---|---|
| 24. | </xs:element> |
| 25. | <xs:element name=“number” minOccurs=“0”/> |
| 26. | <xs:element name=“c” minOccurs=“0” maxOccurs=“unbounded”> |

| | |
|---|---|
| 27. | <xs:annotation> |

| 28. | <xs:documentation>Columns (previous calculations) can be included in the current |
|---|---|
| | calculation.</xs:documentation> |

| | |
|---|---|
| 29. | </xs:annotation> |
| 30. | <xs:complexType> |

| | |
|---|---|
| 31. | <xs:attribute name=“id” type=“xs:integer” use=“required”/> |
| 32. | <xs:attribute name=“type” use=“required”> |

| | |
|---|---|
| 33. | <xs:simpleType> |

| | |
|---|---|
| 34. | <xs:restriction base=“xs:NMTOKEN”> |

| | |
|---|---|
| 35. | <xs:enumeration value=“norm”/> |

| | |
|---|---|
| 36. | </xs:restriction> |

| | |
|---|---|
| 37. | </xs:simpleType> |

| | |
|---|---|
| 38. | </xs:attribute> |
| 39. | <xs:attribute name=“stance” use=“required”> |

| | |
|---|---|
| 40. | <xs:simpleType> |

| | |
|---|---|
| 41. | <xs:restriction base=“xs:NMTOKEN”> |

| | |
|---|---|
| 42. | <xs:enumeration value=“goofy”/> |
| 43. | <xs:enumeration value=“natural”/> |

| | |
|---|---|
| 44. | </xs:restriction> |

| | |
|---|---|
| 45. | </xs:simpleType> |

| | |
|---|---|
| 46. | </xs:attribute> |

| | |
|---|---|
| 47. | </xs:complexType> |

| | |
|---|---|
| 48. | </xs:element> |

| | |
|---|---|
| 49. | </xs:sequence> |
| 50. | <xs:attribute name=“type”> |

| | |
|---|---|
| 51. | <xs:simpleType> |

| | |
|---|---|
| 52. | <xs:restriction base=“xs:NMTOKEN”> |

| | |
|---|---|
| 53. | <xs:enumeration value=“product”/> |
| 54. | <xs:enumeration value=“divide”/> |
| 55. | <xs:enumeration value=“minus”/> |
| 56. | <xs:enumeration value=“sum”/> |
| 57. | <xs:enumeration value=“mean”/> |

| | |
|---|---|
| 58. | </xs:restriction> |

| | |
|---|---|
| 59. | </xs:simpleType> |

| | |
|---|---|
| 60. | </xs:attribute> |

| | |
|---|---|
| 61. | </xs:complexType> |
| 62. | <xs:complexType name=“qType”> |

| | |
|---|---|
| 63. | <xs:simpleContent> |

| | |
|---|---|
| 64. | <xs:extension base=“xs:string”> |

| | |
|---|---|
| 65. | <xs:attribute name=“id” type=“xs:integer” use=“required”/> |
| 66. | <xs:attribute name=“type” use=“required”> |

| | |
|---|---|
| 67. | <xs:simpleType> |

| | |
|---|---|
| 68. | <xs:restriction base=“xs:NMTOKENS”> |

| | |
|---|---|
| 69. | <xs:enumeration value=“currency”/> |
| 70. | <xs:enumeration value=“number”/> |
| 71. | <xs:enumeration value=“percentage”/> |
| 72. | <xs:enumeration value=“dateTime”/> |

| | |
|---|---|
| 73. | </xs:restriction> |

| | |
|---|---|
| 74. | </xs:simpleType> |

| | |
|---|---|
| 75. | </xs:attribute> |
| 76. | <xs:attribute name=“use” use=“optional”> |

| | |
|---|---|
| 77. | <xs:annotation> |

| 78. | <xs:documentation>“Historical” indicates that the historical data should be used in the |
|---|---|
| | calculation; “requested” indicates that the requested data should be used.</xs:documentation> |

| | |
|---|---|
| 79. | </xs:annotation> |
| 80. | <xs:simpleType> |

| | |
|---|---|
| 81. | <xs:restriction base=“xs:NMTOKENS”> |

| | |
|---|---|
| 82. | <xs:enumeration value=“historical”/> |
| 83. | <xs:enumeration value=“requested”/> |

| | |
|---|---|
| 84. | </xs:restriction> |

| | |
|---|---|
| 85. | </xs:simpleType> |

| | |
|---|---|
| 86. | </xs:attribute> |
| 87. | <xs:attribute name=“limit” type=“xs:string” use=“optional”/> |
| 88. | <xs:attribute name=“orderBy” use=“optional”> |

| | |
|---|---|
| 89. | <xs:simpleType> |

| | |
|---|---|
| 90. | <xs:restriction base=“xs:NMTOKENS”> |

| | |
|---|---|
| 91. | <xs:enumeration value=“asc”/> |
| 92. | <xs:enumeration value=“desc”/> |

| | |
|---|---|
| 93. | </xs:restriction> |

| | |
|---|---|
| 94. | </xs:simpleType> |

| | |
|---|---|
| 95. | </xs:attribute> |

| | |
|---|---|
| 96. | </xs:extension> |

| | |
|---|---|
| 97. | </xs:simpleContent> |

| | |
|---|---|
| 98. | </xs:complexType> |
| 99. | <xs:complexType name=“requestType”> |

| | |
|---|---|
| 100. | <xs:sequence> |

| | |
|---|---|
| 101. | <xs:annotation> |

| | |
|---|---|
| 102. | <xs:documentation>Each request has two components - Sellers and Display</xs:documentation> |

| | |
|---|---|
| 103. | </xs:annotation> |
| 104. | <xs:element name=“sellers” type=“small:sellersType”> |

| | |
|---|---|
| 105. | <xs:annotation> |

| 106. | <xs:documentation>Sellers includes all of the information needed to return a result for each |
|---|---|
| | seller you may choose to perform work.</xs:documentation> |

| | |
|---|---|
| 107. | </xs:annotation> |

| | |
|---|---|
| 108. | </xs:element> |
| 109. | <xs:element name=“display” type=“small:displayType”> |

| | |
|---|---|
| 110. | <xs:annotation> |

| 111. | <xs:documentation>Display lists the comparison criteria for the sellers. For example, quality or |
|---|---|
| | cost or duration, or a combination of all three.</xs:documentation> |

| | |
|---|---|
| 112. | </xs:annotation> |

| | |
|---|---|
| 113. | </xs:element> |

| | |
|---|---|
| 114. | </xs:sequence> |
| 115. | <xs:attribute name=“transactionId” type=“xs:integer” use=“required”/> |
| 116. | <xs:attribute name=“requestorId” type=“xs:integer” use=“required”/> |

| | |
|---|---|
| 117. | </xs:complexType> |
| 118. | <xs:complexType name=“displayType”> |

| | |
|---|---|
| 119. | <xs:sequence> |

| | |
|---|---|
| 120. | <xs:element name=“column” maxOccurs=“unbounded”> |

| | |
|---|---|
| 121. | <xs:annotation> |

| 122. | <xs:documentation>Each criteria is displayed in a column. Each row in the column corresponds |
|---|---|
| | to a seller.</xs:documentation> |

| | |
|---|---|
| 123. | </xs:annotation> |
| 124. | <xs:complexType> |

| | |
|---|---|
| 125. | <xs:sequence> |

| | |
|---|---|
| 126. | <xs:element name=“calc” type=“small:calcType”> |

| | |
|---|---|
| 127. | <xs:annotation> |

| 128. | <xs:documentation>Define the calculation for the |
|---|---|
| | column.</xs:documentation> |

| | |
|---|---|
| 129. | </xs:annotation> |

| | |
|---|---|
| 130. | </xs:element> |

| | |
|---|---|
| 131. | </xs:sequence> |
| 132. | <xs:attribute name=“id” type=“xs:integer” use=“required”/> |
| 133. | <xs:attribute name=“returnType” use=“required”> |

| | |
|---|---|
| 134. | <xs:simpleType> |

| | |
|---|---|
| 135. | <xs:restriction base=“xs:NMTOKEN”> |

| | |
|---|---|
| 136. | <xs:enumeration value=“highest”/> |
| 137. | <xs:enumeration value=“lowest”/> |
| 138. | <xs:enumeration value=“all”/> |

| | |
|---|---|
| 139. | </xs:restriction> |

| | |
|---|---|
| 140. | </xs:simpleType> |

| | |
|---|---|
| 141. | </xs:attribute> |

| | |
|---|---|
| 142. | </xs:complexType> |

| | |
|---|---|
| 143. | </xs:element> |

| | |
|---|---|
| 144. | </xs:sequence> |

| | |
|---|---|
| 145. | </xs:complexType> |
| 146. | <xs:complexType name=“sellersType”> |

| | |
|---|---|
| 147. | <xs:sequence> |

| | |
|---|---|
| 148. | <xs:element name=“seller” maxOccurs=“unbounded”> |

| | |
|---|---|
| 149. | <xs:annotation> |

| | |
|---|---|
| 150. | <xs:documentation>List each seller you want to return results for</xs:documentation> |

| | |
|---|---|
| 151. | </xs:annotation> |
| 152. | <xs:complexType> |

| | |
|---|---|
| 153. | <xs:sequence> |

| | |
|---|---|
| 154. | <xs:element name=“questions”> |

| | |
|---|---|
| 155. | <xs:annotation> |

| 156. | <xs:documentation>Questions are the criteria you want to assess the sellers |
|---|---|
| | on. For example, a question could be “Hours of Surveillance requested”. |
| | This requests results for each seller based on the a specific number of |
| | hours of surveillance.</xs:documentation> |

| | |
|---|---|
| 157. | </xs:annotation> |
| 158. | <xs:complexType> |

| | |
|---|---|
| 159. | <xs:sequence> |

| 160. | <xs:element name=“module” type=“small:moduleType” |
|---|---|
| | minOccurs=“0” maxOccurs=“unbounded”> |

| | |
|---|---|
| 161. | <xs:annotation> |

| 162. | <xs:documentation>SmartAlloc has some |
|---|---|
| | special modules, such as the travel |
| | module. The travel module takes origin |
| | suburb(s) and destination suburb(s) and |
| | returns the shortest distance each |
| | seller would have to travel. |
| | </xs:documentation> |

| | |
|---|---|
| 163. | </xs:annotation> |

| | |
|---|---|
| 164. | </xs:element> |
| 165. | <xs:element name=“q” minOccurs=“0” maxOccurs=“unbounded”> |

| | |
|---|---|
| 166. | <xs:annotation> |

| 167. | <xs:documentation>For standard questions |
|---|---|
| | (number of hours of surveillance) a |
| | straight mathematical calculation can |
| | be conducted.</xs:documentation> |

| | |
|---|---|
| 168. | </xs:annotation> |
| 169. | <xs:complexType> |

| | |
|---|---|
| 170. | <xs:simpleContent> |

| 171. | <xs:extension |
|---|---|
| | base=“small:qType”/> |

| | |
|---|---|
| 172. | </xs:simpleContent> |

| | |
|---|---|
| 173. | </xs:complexType> |

| | |
|---|---|
| 174. | </xs:element> |

| | |
|---|---|
| 175. | </xs:sequence> |

| | |
|---|---|
| 176. | </xs:complexType> |

| | |
|---|---|
| 177. | </xs:element> |

| | |
|---|---|
| 178. | </xs:sequence> |
| 179. | <xs:attribute name=“id” type=“xs:integer” use=“required”/> |

| | |
|---|---|
| 180. | </xs:complexType> |

| | |
|---|---|
| 181. | </xs:element> |

| | |
|---|---|
| 182. | </xs:sequence> |

| | |
|---|---|
| 183. | </xs:complexType> |
| 184. | <xs:complexTypename=“addressType”> |

| | |
|---|---|
| 185. | <xs:sequence> |

| | |
|---|---|
| 186. | <xs:element name=“street”/> |
| 187. | <xs:element name=“city”/> |
| 188. | <xs:element name=“state”/> |
| 189. | <xs:element name=“country”/> |

| | |
|---|---|
| 190. | </xs:sequence> |

| | |
|---|---|
| 191. | </xs:complexType> |
| 192. | <xs:complexType name=“moduleType”> |

| | |
|---|---|
| 193. | <xs:sequence> |

| | |
|---|---|
| 194. | <xs:element name=“origins”> |

| | |
|---|---|
| 195. | <xs:annotation> |

| 196. | <xs:documentation>The list of charge-out points for each seller. This data will commonly be |
|---|---|
| | received from a separate call to a SOAP server that lists the charge-out points of each of |
| | seller listed in your request.</xs:documentation> |

| | |
|---|---|
| 197. | </xs:annotation> |
| 198. | <xs:complexType> |

| | |
|---|---|
| 199. | <xs:sequence> |

| | |
|---|---|
| 200. | <xs:element name=“origin” maxOccurs=“unbounded”> |

| | |
|---|---|
| 201. | <xs:complexType> |

| | |
|---|---|
| 202. | <xs:sequence> |

| | |
|---|---|
| 203. | <xs:element name=“address” type=“small:addressType”/> |

| | |
|---|---|
| 204. | </xs:sequence> |

| | |
|---|---|
| 205. | </xs:complexType> |

| | |
|---|---|
| 206. | </xs:element> |

| | |
|---|---|
| 207. | </xs:sequence> |

| | |
|---|---|
| 208. | </xs:complexType> |

| | |
|---|---|
| 209. | </xs:element> |
| 210. | <xs:element name=“destinations”> |

| | |
|---|---|
| 211. | <xs:annotation> |

| | |
|---|---|
| 212. | <xs:documentation>List of locations that the work will be conducted in.</xs:documentation> |

| | |
|---|---|
| 213. | </xs:annotation> |
| 214. | <xs:complexType> |

| | |
|---|---|
| 215. | <xs:sequence> |

| | |
|---|---|
| 216. | <xs:element name=“destination” maxOccurs=“unbounded”> |

| | |
|---|---|
| 217. | <xs:complexType> |

| | |
|---|---|
| 218. | <xs:sequence> |

| | |
|---|---|
| 219. | <xs:element name=“address” type=“small:addressType”/> |

| | |
|---|---|
| 220. | </xs:sequence> |

| | |
|---|---|
| 221. | </xs:complexType> |

| | |
|---|---|
| 222. | </xs:element> |

| | |
|---|---|
| 223. | </xs:sequence> |

| | |
|---|---|
| 224. | </xs:complexType> |

| | |
|---|---|
| 225. | </xs:element> |

| | |
|---|---|
| 226. | </xs:sequence> |
| 227. | <xs:attribute name=“qid” type=“xs:integer” use=“required”/> |
| 228. | <xs:attribute name=“type” use=“required”> |

| | |
|---|---|
| 229. | <xs:simpleType> |

| | |
|---|---|
| 230. | <xs:restriction base=“xs:NMTOKENS”> |

| | |
|---|---|
| 231. | <xs:enumeration value=“travel”/> |

| | |
|---|---|
| 232. | </xs:restriction> |

| | |
|---|---|
| 233. | </xs:simpleType> |

| | |
|---|---|
| 234. | </xs:attribute> |
| 235. | <xs:attribute name=“calcMethod” use=“required”> |

| | |
|---|---|
| 236. | <xs:simpleType> |

| | |
|---|---|
| 237. | <xs:restriction base=“xs:NMTOKENS”> |

| | |
|---|---|
| 238. | <xs:enumeration value=“oneToMany”/> |

| | |
|---|---|
| 239. | </xs:restriction> |

| | |
|---|---|
| 240. | </xs:simpleType> |

| | |
|---|---|
| 241. | </xs:attribute> |
| 242. | <xs:attribute name=“calcOperation” use=“required”> |

| | |
|---|---|
| 243. | <xs:simpleType> |

| | |
|---|---|
| 244. | <xs:restriction base=“xs:NMTOKENS”> |

| | |
|---|---|
| 245. | <xs:enumeration value=“sum”/> |

| | |
|---|---|
| 246. | </xs:restriction> |

| | |
|---|---|
| 247. | </xs:simpleType> |

| | |
|---|---|
| 248. | </xs:attribute> |
| 249. | <xs:attribute name=“returnType” use=“required”> |

| | |
|---|---|
| 250. | <xs:simpleType> |

| | |
|---|---|
| 251. | <xs:restriction base=“xs:NMTOKENS”> |

| | |
|---|---|
| 252. | <xs:enumeration value=“distance”/> |
| 253. | <xs:enumeration value=“travelTime”/> |

| | |
|---|---|
| 254. | </xs:restriction> |

| | |
|---|---|
| 255. | </xs:simpleType> |

| | |
|---|---|
| 256. | </xs:attribute> |

| | |
|---|---|
| 257. | </xs:complexType> |

| | |
|---|---|
| 1 | </xs:schema> |

We claim:

1. A system for enabling the selection of a service provider from a plurality of service providers for the performance of a job, said system including:
a database which is accessible by a service user via a network, the database including a plurality of records, each record being associated with a service provider, wherein each record includes a service provider profile including a plurality of comparable performance criteria indicative of the performance attributes of the service provider;
an interface for receiving a job request comprising at least one desired performance criterion from said service user, and
a processor for comparing the stored comparable performance criteria and the at least one desired performance criterion, and for extracting at least one preferred service provider from the database on the basis of said comparison.

2. A system as claimed in claim 1 in which the processor is arranged to extract a plurality of service providers from the database on the basis of said comparison, and to compile a list of the plurality of preferred service providers for distribution to the service user.

3. A system as claimed in claim 2 wherein said database is additionally accessible by said service providers via a network for enabling the service providers to update their associated performance profiles.

4. A system as claimed in claim 1 which includes prioritising means for allowing at least two desired performance criteria to be prioritised in accordance with user-selected priorities, and wherein said comparison is made in accordance with said prioritisation.

5. A system as claimed claim 1 which includes weighting means for weighting at least some of the comparable performance criteria according to their relative importance to the user, to enable said comparison to be made in accordance with said weightings.

6. A system as claimed in claim 1 wherein said database includes at least one historical rating field associated with each service provider for enabling a service user to rate at least one past job performed by the service provider.

7. A system as claimed in claim 1 wherein said at least one desired performance criterion and said comparable performance criteria are selected from a group including the following classes of criteria:
quality criteria, cost criteria and timeliness criteria.

8. A system as claimed in claim 7 wherein said quality criteria relate to the quality and extent of the resources drawn on by the service provider.

9. A system as claimed in claim 7 wherein said cost criteria relate to at least one of the following, namely the current cost structure of the service provider, the average cost of similar jobs performed by the service provider in the past, and discounts offered by the service provider.

10. A system as claimed in claim 7 wherein said timeliness criterion reflects the timeliness of at least one past job performed by the service provider.

11. A system according to claim 1 in which each service provider profile includes at least one qualifying criterion indicative of the ability of the service provider to perform the job, and wherein the job request includes at least one desired qualifying criterion.

12. A system as claimed in claim 11 in which said qualifying criteria relate to at least one of the following, namely the type of service, the area of operation of the service provider and the availability of the service provider.

13. A system as claimed in claim 1 wherein said interface is adapted to receive a selection confirmation from said service user identifying the service provider selected for the job.

14. A system as claimed in claim 1 wherein said system additionally includes generating means for generating and sending a job confirmation message to the service provider selected by the service user for the job.

15. A system as claimed in claim 1 wherein the job to be performed is an investigation.

16. A method of enabling a service user to select a service provider from a plurality of service providers for the performance of a job, said method including:
providing a database which is accessible by the service user via a network,
storing in said database a plurality of records, each record being associated with a service provider, wherein each record includes a service provider profile including a plurality of comparable performance criteria indicative of the performance attributes of the service provider;
receiving a job request comprising at least one desired performance criterion from said service user,
comparing the plurality of stored performance criteria with the desired performance criterion, and automatically selecting at least one preferred service provider from the database on the basis of said comparison.

17. A method as claimed in claim 16 in which a plurality of preferred service providers are automatically selected from the database, and said method additionally includes compiling a list of the plurality of preferred service providers.

18. A method as claimed in claim 16 which includes:
periodically capturing and storing updated performance criteria in order to update the stored profile of least one service provider.

19. A method as claimed in claim 18 in which said database is accessible by said plurality of service providers and wherein said method includes:
enabling the service providers periodically to update their associated performance profiles in the database.

20. A method as claimed in claim 16 in which said job request includes a plurality of desired performance criteria and wherein said method additionally includes:
enabling the service user to prioritise at least two desired performance criteria; and
automatically selecting the at least one preferred service provider on the basis of the prioritisation.

21. A method as claimed in claim 16 which includes:
allowing said user to allocate a weighting to said comparative performance criteria indicative of the relative importance of said comparative performance criteria to the service user; and
automatically selecting the at least one preferred service provider at least partly on the basis of said weighting.

22. A method as claimed in claim 16 wherein said database includes at least one historical rating field associated with each service provider, and wherein said method includes:
enabling a service provider to rate at least one past job performed by said service provider; and
capturing said rating in said at least one historical rating field associated with the service provider.

23. A method as claimed in claim 19 in which each of said service provider profiles includes at least one stored qualifying criterion indicative of the ability of a service provider to perform the job, and in which said job request includes at least one qualifying criterion, wherein said method includes;
comparing said stored qualifying criterion with said desired qualifying criterion to select at least one qualified service provider on the basis of said comparison,
wherein at least one preferred service provider is a subset of at least one qualified service provider so selected.

24. A method as claimed in claim 16 wherein said services are insurance investigation services.

25. A system as claimed in claim 5 in which said weighting means operates according to the formula
$$\frac{{\sum }_{i = 1}^{n} {Rating}_{i} \cdot {Criterion}_{i}}{5 \cdot n}$$
where Weightingi is the weighting of the ith performance criterion allocated by the service user on a scale of 1 to X, and, Criterioni is the value for the ith performance criterion stored in the database for each the service provider, and n is the total number of performance criterion.

26. A computerized method of enabling a buyer to select a service provider for performing a service; said method including:
(a) processing a service enquiry for a particular service;
(b) retrieving historical cost data associated with said service in respect of a plurality of service providers in response to said enquiry;
(c) processing said historical cost data to arrive at comparable cost data in respect of said service providers for enabling the selection of a service provider to perform the particular service;
(d) capturing cost data relating to the provision of the particular service by the selected service provider, and
(e) updating the historical cost data by incorporating said captured cost data.

27. A method as claimed in claim 26 which includes repeating steps (a) to (e) to enable a buyer to select a service provider for the provision of subsequent services with the aid of regularly updated cost data.

28. A method as claimed in claim 27 which includes compiling an historical cost dataset including historical cost data associated with the provision of at least one similar previous service by each service provider.

29. A method as claimed in claim 26 wherein the service enquiry includes a plurality of service components and the historical cost data includes historical cost data for a plurality of comparable service components, and step (c) includes:
processing said historical cost data to arrive at cost data for each of said service components.

30. A method as claimed in claim 26 wherein the cost data captured in step (d) includes cost data for each of the service components included in the service enquiry.

31. A method as claimed in claim 30 in which the service components include cost per unit of time and distance, in combination together with units of time and distance.

32. A method as claimed in claim 30 which includes:
(f) retrieving historical quality data associated with said service in respect of a plurality of service providers in response to said enquiry; and
(g) processing said historical quality data to arrive at comparable quality data in respect of said service providers to enable the selection of a service provider to perform the particular service.

33. A method as claimed in claim 32 which includes:
(h) capturing quality data relating to the provision of the particular service by the selected service provider; and
(i) updating the historical quality data to reflect said captured quality data.

34. A method as claimed in claim 33 which includes:
Repeating steps (f) to (i) to assist a buyer to select a service provider for the provision of subsequent services with the aid of regularly updated quality data.

35. A method as claimed in claim 34 which includes:
compiling a historical quality dataset including historical quality data associated with the provision of at least one previous service by each service provider.

36. A method as claimed in claim 32 wherein the historical quality data includes historical quality data for a plurality of performance attributes, and the service request enquiry includes a plurality of comparable performance attribute weightings reflecting the relative importance of at least two of the performance attributes to the buyer.

37. A method as claimed in claim 32 wherein step (g) includes:
processing said historical quality data in respect of each of the performance attributes to arrive at comparable performance data in respect of each performance attribute, and combining said comparable performance data according to performance attribute weightings contained in the service enquiry for each service provider, to generate said comparable quality data.

38. A method as claimed in claim 32 which includes quantifying the selected quality factors using any derived scale, weighting such factors according to their relative importance, normalising the factors and combining them with the similarly normalised historical cost factors, in combination with an additional weighting factor.

39. A method as claimed in claim 32 wherein the comparable cost data and comparable quality data in respect of each of the service providers is combined to derive a comparable performance index for each service provider for enabling the selection of a service provider to perform the particular service, with the combination of the comparable cost data and comparable quality data being arranged in accordance with weightings reflecting the relative importance of the comparable cost data and comparable quality data to the buyer.

40. A computerized method of enabling a buyer to select a service provider for performing a service, said method including:
(a) compiling historical cost and quality datasets including historical cost and quality data associated with the provision of at least one previous service by each service provider.
(b) receiving and processing a service enquiry from the buyer for a particular service;
(c) retrieving historical cost and quality data associated with said service in respect of a plurality of service providers in response to said enquiry; and
(d) processing said historical cost and quality data to arrive at comparable cost and quality data in respect of said service providers for enabling the selection of a service provider to perform the particular service.

41. A method as claimed in claim 40 which includes:
(e) capturing cost and quality data relating to the provision of the particular service by the selected service provider;
(f) updating the historical cost and quality data to incorporate said captured cost and quality data, and repeating steps (b) to (f) to enable a buyer to select a service provider for the provision of subsequent services.

42. A method as claimed in claim 40 which includes formatting the service enquiry into a plurality of service components, and formatting the historical cost and quality data into a plurality of comparable service components, with step (d) including:
processing said historical cost and quality data to arrive at cost and quality data for each of said components.

43. A computer-readable medium having stored thereon executable instructions for causing a computer to perform a method of enabling a buyer to select a service provider for performing a service; said method including:
(a) processing a service enquiry for a particular service;
(b) retrieving historical cost data associated with said service in respect of a plurality of service providers in response to said enquiry;
(c) processing said historical cost data to arrive at comparable cost data in respect of said service providers for enabling the selection of a service provider to perform the particular service;
(d) capturing cost data relating to the provision of the particular service by the selected service provider, and
(e) updating the historical cost data by incorporating said captured cost data.

44. The computer-readable medium as claimed in claim 43 having further executable instructions for causing a computer to repeat steps (a) to (e) to enable a buyer to select a service provider for the provision of subsequent services with the aid of regularly updated cost data.

45. A computer operating under the control of the computer readable medium of claim 43.

46. A computer system to enable a buyer to select a service provider for performing a service, said system including:
an enquiry processing device configured to receive and process a service enquiry for a particular service from the buyer;
a database configured to store historical cost data associated with said service in respect of a plurality of service providers;
a processor adapted to retrieve and process said historical cost data from said database in response to said query to arrive at comparable cost data in respect of said service providers for enabling the buyer to select a service provider, on the basis of said comparable cost data, to perform the particular service.

47. A computer system as claimed in claim 46 which includes:
a data capture component configured to capture cost data relating to the provision of the particular service by the selected service provider, and updating means to update the historical cost data on the database with said captured cost data.

48. A computer system as claimed in claim 46 in which the database includes:
a data compilation component configured to compile a dataset including historical cost and quality data associated with the provision of at least one previous service by each service provider.

49. A computer system as claimed in claim 46 wherein the enquiry processing device is configured to additionally retrieve historical quality data associated with said service in respect of a plurality of service providers in response to said enquiry, and the enquiry processing device is configured to generate comparable quality data from said historical quality data in respect of said service providers.

50. A computer system as claimed in claim 49 wherein the historical quality data includes historical quality data, for a plurality of performance attributes, and the service request enquiry includes a plurality of comparable performance attribute weightings reflecting the importance of each of the performance attributes to the buyer.

51. A computer system as claimed in claim 50 wherein the processor is configured to process said historical quality data in respect of each of the performance attributes to arrive at comparable performance data in respect of each performance attribute, and to combine the comparable performance data according to the performance attribute weightings included in the service enquiry for each service provider, to generate said comparable quality data.

52. A computer system as claimed in claim 49 wherein the processor is configured to derive a comparable performance index for each service provider by combining the comparable cost data and comparable quality data in respect of each of the service providers with the combination of the comparable cost data and comparable quality data being is performed in accordance with weightings reflecting the relative importance of the comparable cost data and comparable quality data to the buyer.

53. A computer system to enable a buyer to select a service provider for performing a service; said system including:
a database configured to store a first dataset including a plurality of service providers, a plurality of associated services and a plurality of associated historical costs;
a processor in communication with said database, wherein said processor is configured to receive historical cost data associated with each service provider and to generate comparative cost data for each service provider according to a predetermined algorithm; and
a communication device configured to communicate said comparative cost data to said buyer to enable the buyer to select a service provider.

54. A computer system as claimed in claim 53 wherein the predetermined algorithm includes weighting means configured to weight a plurality of received historical cost data according to the respective associated service of the historical cost data, and to generate the comparative cost data in accordance with said weighting.

55. A computer system as claimed in claim 54 wherein said processor includes weighting optimisation means adapted to optimise the weightings applied by the weighting means to the received historical cost data, with the weighting optimisation means utilizing an algorithm which has the effect of weighting the most recent data more heavily.

56. A computer system as claimed in claim 53 which further includes data capture means configured to capture cost data associated with a current service provided by a service provider, and updating means adapted to update said first data set to include said cost data associated with the current service provided by a service provider.

57. A computer system as claimed in claim 53 wherein the historical cost data includes a plurality of associated service components and associated historical cost component data; and the processor is configured to generate comparative cost data in respect of each service component for each service provider.

58. A computer system as claimed in claim 53 wherein the data storage means is configured to store a second dataset including a plurality of service providers, a plurality of associated services and a plurality of associated historical quality data, and said processor means is configured to additionally receive historical quality data associated with each service provider and generate comparative quality data for each service provider according to a predetermined algorithm; and said communication means is arranged to communicate said comparative quality data to the buyer to enable the buyer to select a service provider.
